(19) United States
(12) Patent Application Publication
(10) Pub. No.: US 2022/0228960 A1
(43) Pub. Date: Jul. 21, 2022

(54) RHEOLOGY-INFORMED NEURAL NETWORKS FOR COMPLEX FLUIDS

(71) Applicant: Northeastern University, Boston, MA (US)

(72) Inventors: Mohammadamin Mahmoudabadbozchelou, Boston, MA (US); Safa Jamali, Boston, MA (US)

(21) Appl. No.: 17/581,076

(22) Filed: Jan. 21, 2022

Related U.S. Application Data
(60) Provisional application No. 63/140,043, filed on Jan. 21, 2021.

(51) Int. Cl. G01N 9/00; G06N 3/04

(52) U.S. Cl. CPC G01N 9/00; G06N 3/04

(57) ABSTRACT

A comprehensive machine-learning algorithm, namely a Multi-Fidelity Neural Network (MFNN) architecture, is disclosed for data-driven constitutive meta-modelling of complex fluids. The physics-based neural networks are informed by underlying rheological constitutive models through synthetic generation of low-fidelity model-based data points.

### CROSS REFERENCE TO RELATED APPLICATION

This application claims priority from U.S. Provisional Patent Application No. 63/140,043 filed on Jan. 21, 2021 entitled Rheology-Informed Neural Networks for Complex Fluids, which is hereby incorporated by reference.

### BACKGROUND

Over the past few decades, many engineering/scientific software packages have been developed to perform fluid mechanical and rheological simulation of a given geometry/material/processing condition. However, these packages have generally not found the same success in industrial settings as in academic environments, due to lack of accuracy, adaptability, and ease of use. There has been increasing use of artificial intelligence (AI) and machine learning algorithms in all avenues of science. However, technical issues in rheology, fluid mechanics, and material science, and engineering have limited use of such tools. To benefit from machine learning algorithms, we developed a methodology built on physics-informed neural networks. Various embodiments disclosed herein relate to a physical-based machine learning framework.

The technology disclosed herein leverages advances in artificial intelligence and machine learning in solving complex problems in materials science and complex fluids. In one or more embodiments, this is performed by using two interconnected neural networks, each having many hidden layers and neurons. In one of the two neural networks, synthetic data generated from conventional models are used as inputs, and the other NN uses actual experimental data on the problem under investigation. This significantly reduces the number of data points needed to perform meaningful machine-learning predictions. The physical intuition into the problem plays a key role in providing reliable predictions, and thus the choice of model, the number of data, and the type of predictions will be influenced by that choice. Furthermore, contrary to usual deep learning platforms, our technology is capable of predicting behavior/results outside the training window, since these predictions are enabled by physical models. This can be used for accelerated material design and discovery, and for predicting the rheological behavior of complex systems across a wide range of conditions.

Features of the technology include (1) significantly reduced data required to provide reliable predictions; (2) an agile and adaptable model to new materials/processes without the need to change the model; (3) enables accelerated material design and discovery by predicting behavior; and (4) enables fast and accurate modeling of complex fluids in very complex processing/operating conditions, conventionally not accessible by other models.

The traditional methods of modeling can be categorized into two categories: phenomenological and empirical modeling. In both of these methods, the accuracy is dependent on the material and the process; in some materials the model might work, but not for others. In addition, one needs to spend a lot of time and money to perform several experiments and create a big data set able to use one of the aforementioned traditional methodologies. The technology disclosed herein decreases the need for a big data set and increases accuracy. That means by spending less time and money, one could get more accurate results. As opposed to crude mathematical modeling of a problem in an industrial setting, where materials can include many non-ideal components, with multiple variables and processing conditions all represented as sheer parameters, our approach by understanding the underlying physical phenomena, performs the prediction with all standing variables as inputs to the neural network and thus becomes much more adaptable to different non-expert industrial users.

A wide range of users can benefit from the disclosed methodology. For example, besides academic users who may be interested in pursuing different research ideas using this method, a spectrum of industries can benefit from the invention including, e.g., consumer products, chemical companies, plastic and polymer industry in general, pharmaceutical companies, and oil/gas industries.

Commercial use of the software includes, but is not limited to, adaptive modeling of processing/design/behavior of complex fluids in consumer products, and polymer/plastic industries, which is the case on a routine basis at oil/gas companies and pharmaceuticals companies.

The technology can also be used by academics as well as any scientist active in material design and discovery. The technology can be used at national labs, federal agencies such as DoD, NASA, NIST and other centers with ongoing research on complex materials and fluids.

With conventional technology, in order to model, describe and predict a complex fluid or a soft material's behavior under real processing condition, different equations are developed with several parameters that do not necessarily reflect on all the actual parameters in life, but are correlated to. For instance, a material may consist of 10 different components (different particles, polymers, fluids, aromatics, etc.) under a process with 10 different conditions (temperature, rate, pH, pressure, etc.). The model may have a few parameters for brevity that reflect on all of these components combined. So, by changing the composition of the material, or changing the process conditions, one will need to do exhaustive experiments, to find the new model parameters. This is referred to as reduced-order modeling. The technology disclosed herein instead inputs all of the above mentioned components and parameters directly to the neural network and thus is not a reduced order model. As such, by changing each parameter, the machine provides a direct prediction without the need for any new experiments. This not only saves time, but is also extremely cost effective and accurate.

### BRIEF SUMMARY OF THE DISCLOSURE

A comprehensive machine-learning algorithm, namely a Multi-Fidelity Neural Network (MFNN) architecture, is disclosed for data-driven constitutive meta-modelling of complex fluids. The physics-based neural networks are informed by underlying rheological constitutive models through synthetic generation of low-fidelity model-based data points. The performance of these rheologically-informed algorithms is investigated and compared against classical Deep Neural Networks (DNN). The MFNNs are found to recover the experimentally observed rheology of a multi-component complex fluid consisting of several different colloidal particle, wormlike micelles and other oil and aromatic particles. Moreover, the data-driven model is capable of successfully predicting the steady state shear viscosity of this fluid under a wide range of applied shear rates based on its constituting components. Building upon the demonstrated framework, we present the rheological predictions of a series of multi-component complex fluids made by DNN and MFNN. We show that by incorporating the appropriate physical intuition into the neural network, the MFNN algorithms captures the role of experiment temperature, the salt concentration added to the mixture, as well as aging within and outside the range of training data parameters. This is made possible by leveraging abundance of synthetic low-fidelity data that adhere to specific rheological models. In contrast, a purely data-driven DNN is consistently found to predict erroneous rheological behavior.

In one or more embodiments, a computer-implemented method is disclosed of predicting one or more rheological properties of a non-Newtonian fluid using a multi-fidelity neural network framework. The method includes the steps performed by a computer system of: (a) receiving, at a physics-informed low fidelity neural network, a plurality of low fidelity parameter inputs related to the non-Newtonian fluid; (b) generating, by the physics-informed low fidelity neural network, one or more synthetically generated parameters of the non-Newtonian fluid based on the plurality of low fidelity parameter inputs; (c) receiving, at a physics-informed high fidelity neural network, the at least one or more synthetically generated parameters of the non-Newtonian fluid and one or more high fidelity parameter inputs related to the non-Newtonian fluid; (d) generating, by the physics-informed high fidelity neural network, the one or more rheological properties of the non-Newtonian fluid based on the high fidelity parameter inputs and the at least one or more synthetically generated parameters related to the non-Newtonian fluid; and (e) outputting, by the computer system, the one or more rheological properties of the non-Newtonian fluid generated in (d).

### BRIEF DESCRIPTION OF THE DRAWINGS

FIG. 1 is a schematic view illustrating operation of an exemplary multi-fidelity neural network (MFNN) in accordance with one or more embodiments and a deep neural network (DNN). The inputs to the DNN architecture are the experimental measurements, while the MFNN architecture leverages the abundance of low-fidelity data points synthetically generated through different models as well as accuracy of experimental data as the high-fidelity dataset.

FIG. 2 is a graph showing the mean relative absolute error of the MFNN as a function of the number of low-fidelity data. The number of high-fidelity data is always the entire data set at hand, which in this study for is 18 series of data points, each spanning over 42 different applied shear rates.

FIG. 3 is a graph showing the regression between the actual experimental results and results predicted using MFNN and DNN algorithms for the steady state shear viscosity of sample 5. The MFNN is informed by LF data generated through a TCC model.

FIGS. 4A and 4B (collectively FIG. 4) are graphs showing flow curve predictions made by three different methods: a TCC constitutive equation (model), multi-fidelity neural network (MFNN), and a classical deep neural network (DNN) for two different samples with known TCC model parameters to generate LF data points. FIG. 4A (sample 9) and FIG. 4B (sample 13) correspond to two different samples for illustrative purposes and removing system-specific biases.

FIG. 5 is a graph illustrating the regression between the actual experimental results and the results predicted by three different neural network algorithms: classical deep neural network (DNN), physics-informed network based on Power-Law model (MFNN-PL), and physics-informed network based on Herschel-Bulkley model (MFNN-HB) for the steady-state shear viscosity of sample 5.

FIGS. 6A and 6B (collectively FIG. 6) are graphs showing the experimentally measured steady state shear viscosity flow curves compared to the predictions made by the neural networks using: no physics (DNN), Power-Law physics (MFNN-PL) and Herschel-Bulkley physics (MFNN-HB). FIG. 6A (sample 11) and FIG. 6B (sample 13) correspond to two different samples for illustrative purposes and removing system-specific biases.

FIGS. 7A and 7B (collectively FIG. 7) are graphs showing the experimentally measured steady state shear viscosity flow curves compared to fully predicted flow curves through: no-physical basis incorporated into the neural network (DNN), the TCC model with coefficients interpolated using other samples at hand (model), and physics-based neural network using SVM-predicted TCC coefficients as the physical intuition. FIG. 7A (sample 3) and FIG. 7B (sample 9) correspond to two different samples for illustrative purposes and removing system-specific biases.

FIG. 8 is a graph showing the regression between actual experimental viscosities measured and the NN-predicted viscosities for an unknown sample (sample 3) using DNN and MFNN.

FIG. 9 is a graph showing three sets of flow curves: blue and purple lines represent the shear viscosity behavior over different shear rates at 25° C. and 40° C., respectively. The green line shows the monotonic viscosity decrease against the temperature at the constant shear rate of 2s⁻¹.

FIGS. 10A and 10B (collectively FIG. 10) are graphs showing the prediction of shear viscosity vs. shear rate behavior made through simple deep neural network (DNN) and physics-informed multi-fidelity neural network (MFNN) at the test temperature of 40° C. based on an initial experiment temperature of 25° C. and a temperature ramp from 25° C. to 40° C., at a constant shear rate of 2s⁻¹. FIG. 10A (sample 16) and FIG. 10B (sample 17) correspond to two different samples for illustrative purposes and removing system-specific biases.

FIG. 11 is a graph showing the role of salt concentration on the shear viscosity vs. shear rate behavior of sample 3 over three different salt concentrations.

FIGS. 12A and 12B (collectively FIG. 12) are graphs showing the prediction of shear viscosity vs. shear rate behavior made through simple deep neural network (DNN) and physics-informed multi-fidelity neural network (MFNN) at the salt concentration of 2 based on salt concentrations of 1 and 3 (interpolation). FIG. 12A (sample 10) and FIG. 12B (sample 18) correspond to two different samples for illustrative purposes and removing system-specific biases.

FIGS. 13A and 13B (collectively FIG. 13) are graphs showing the prediction of shear viscosity vs. shear rate behavior made through simple deep neural network (DNN) and physics-informed multi-fidelity neural network (MFNN) at the salt concentration of 3 based on salt concentrations of 1 and 2 (extrapolation). FIG. 13A (sample 3) and FIG. 13B (sample 18) correspond to two different samples for illustrative purposes and removing system-specific biases.

FIG. 14 is a graphs showing steady state shear viscosity vs. shear rate behavior of a multi-component sample tested over a time period of one year. The color increments indicate the aging of the sample from fresh (0 month) up to 1 year of aging.

FIGS. 15A and 15B (collectively FIG. 15) are graphs showing the predictions made for the viscosity vs. shear rate behavior of a multi-component complex fluid, aged for 12 months through (FIG. 15A) DNN (FIG. 15B) MFNN architectures. The dashed lines represent the experimentally measured viscosities of the sample 13 after 1 year of aging. While all predictions are made for the sample aged for 12 months, the color increments represent the amount of training data sets provided before those predictions are made for each NN.

FIGS. 16A, 16B, 16C, and 16D (collectively FIG. 16) are graphs showing the MFNN predictions of shear viscosity vs. shear rate behavior for an unknown sample (sample 13) based on its compositions, at different aging times of: (FIG. 16A) 3 months, (FIG. 16) 6 months, (FIG. 16C) 9 months, and (FIG. 16D) 12 months.

FIGS. 17A and 17B (collectively FIG. 17) are graphs showing the: the residual of training process for (FIG. 17A) MFNN, (FIG. 17B) DNN. In FIG. 17A, the magnitude of residual for both low-fidelity and high-fidelity networks as well as total magnitude of loss for MFNN is shown during training process.

FIG. 18 shows TABLE I: the constituent components/formulation of different samples tested from sample to sample.

FIG. 19 shows TABLE II: the mean relative absolute error (RAE) based on different NN architectures base d on their number of hidden layers (depth) and neurons per layer (width) on a single sample, keeping all other variables constant.

FIG. 20 shows TABLE III: the percentage error between the fitted-to-experiment TCC model parameters, and SVM-predicted TCC model parameters for sample 3 as in FIG. 7.

FIG. 21 is a simplified block diagram illustrating an exemplary computer system in which methods disclosed herein may be implemented.

### DETAILED DESCRIPTION

Many complex and structured fluids exhibit a wide range of rheological responses to different flow characteristics owing to their evolving internal structures¹⁻⁸. The ability to represent this complex rheological behavior through closed-form constitutive equations constructed from kinematic variables is essential in better understanding and designing these complex fluids and their processing conditions. Thus, efforts in constitutive modelling of complex fluids date back to inception of the field of rheology itself⁹⁻¹¹. However, as the material's response to an applied deformation or stress becomes more complicated, so does the constitutive model of choice to describe such response, resulting in more model parameters and hence more experimental protocols to determine those parameters. Generalized Newtonian fluids are a class of constitutive equations in which different functional forms are designated to represent the changes in the non-Newtonian viscosity¹²⁻¹⁴. For instance, the power-law (PL) model represents a single exponent rate dependence, which can take a shear thinning^{15,16} or shear thickening¹⁷ form. The PL model can be simply written as equation 1, where k and n are the only two model parameters.

σ=k\dot{γ}ⁿ (1)

Very often, structured fluids exhibit a yield stress under which the material does not flow, and upon reaching this critical yield stress begins to flow^{18,19}. In its simplest form, where this flow is rate independent, this behavior can be captured through a Bingham plastic model¹⁰ shown as equation 2, where σ_{y} is the yield stress, and k is the continuous phase viscosity.

σ=σ_{y}+k\dot{γ} (2)

Although equation 2 has two model parameters, it does not reflect on the rate dependence of the fluid. The majority of the yield stress fluids exhibit a non-linear dependency with the shear rate upon reaching the yield stress²⁰⁻²⁶. A combination of equations 1 and 2 leads to the so-called Herschel-Bulkley (HB) model⁹ with three different parameters, in which the viscosity itself is related to the shear rate in a non-linear way.

σ=σ_{y}+k\dot{γ}ⁿ (3)

While the HB model successfully describes the flow curve of a wide range of yield stress materials, a direct connection of the parameter value to the underlying microscopic physics determining the viscosity is not clear. In fact, the PL and HB model have clear limitations in the ability to extrapolate at high shear rate, predicting vanishing low viscosity at high shear rate for any n values smaller than 1. This is not a problem for many applications but clearly shows that the model does not capture the physics controlling the viscosity. For this reason, a number of attempts have been made to derive constitutive models that better connect microstructure and bulk rheological properties'''. One example is the Three Component model (TC)²⁶, recently proposed as a physically based alternative to the HB model shown as equation 4. In this model, the scaling of the different dissipation mechanisms is fixed and the three parameters have clear physical meaning.

σ=σ_{y}+Γ_{y}(\dot{γ}/\dot{γ}_{c})^{0.5}+η_{bg}\dot{γ} (4)

The rheological response of complex and structured fluids to a change in thermomechanical or thermochemical environment may take a variety of forms. For example, for rheologically simple fluids, increasing the temperature usually in turn decreases the viscosity of fluid, which can be explained through an Arrhenius-like description¹⁴; however, this relationship becomes more complex when changing the temperature also changes the interactions between the constructing constituents. For instance, thermo-reversible gels show jumps in their moduli upon reaching a critical temperature that effectively induces gelation in the system³⁰.

The same effect can be observed by changing the salinity of a mixture. As salt is added to a particulate system, charge screening around different particles results in changing the effective interactions between them, and hence formation/breakage of particle-particle bonds and structures³¹⁻³³. This structure and network formation subsequently changes the macroscopic rheological measures of the system entirely. The slow aging of these structure is another factor that can change the rheology of a structured fluid³⁴⁻³⁹. The structure of the colloidal gel coarsens over time in a continuous and nontrivial manner, which in turn changes the measured moduli of the material. Nonetheless, the timescale for this aging behavior is significantly longer that initial network formation, or single particle diffusion timescale, and also depends on the interactions between the particles as well as the fraction of solid content in a mixture⁴⁰⁻⁴⁸. Since the material is ever changing with respect to its microstructure, the rheological behavior of the system cannot be expressed through traditional constitutive models where this time-dependence is not mathematically present. These structure-rheology couplings are not limited to colloidal gels and can be extended to all systems where the primary components of the system form structures that affect the physical behavior. For instance, surfactant molecules in aqueous solutions can self-assemble to form Wormlike micelles WLMs with a distinct rheological behavior. Experimental and theoretical studies on the structure and rheology of WLM solutions show a range of exotic rheological responses to different applied deformations and fields⁴⁹⁻⁵⁴.

For many decades, phenomenological models (from early models such as Maxwell and Kelvin, to most recent such as Iso-Kinematic Hardening and other thixotropic models with microstructural parameters⁵⁵) have been developed and employed for understanding the underpinning physics of a problem. These are extremely important developments as they provide an invaluable insight to the underlying physics of a particular phenomenon. This makes such constitutive models perfect candidates to study and understand ideal rheological behaviors. Nonetheless, as the material becomes multi-component and more complex, the number of additional parameters required to fully capture the rheological response of the fluid to an applied deformation increases and eventually becomes computationally prohibitive. In other words, the diversity of rheological responses observed in these structured fluids make it a very challenging task to represent these behaviors through constitutive models with optimal number of model parameters. The emergence of multiple time and length scales due to structure formation and break up at different local or global scales⁵⁶⁻⁵⁸ requires combining different models or increasing the number of parameters to make a phenomenological model of choice more adaptive. For instance, one can imagine that the model parameters that describe the time-evolution of the structure parameter or yield stress for colloidal gels⁵⁹⁻⁶³, bear some physical intuition to temperature dependence, aging, salinity, as well as other deterministic factors. However, since these parameters do not necessarily carry a direct physical underpinning and are often difficult to fit using experimental results, erroneous predictions begin to emerge. This is even more pronounced when real-world fluids with multiple interacting particles and constituents are under question. A complex fluid of choice may consist of different solid particles with different chemical identities (hence, different physical interactions), surfactants, different polymers, aqueous and non-aqueous simple fluids. For these multi-component systems, where the fluid behavior is governed by structure formation and break-up at several length-scales and is strictly coupled to the thermomechanochemical identity and history of the fluid, devising a meaningful constitutive relation between deformation and stress that represents the time-, salinity-, and age-dependence of the fluid is extremely challenging, if possible, at all.

With an ever-increasing computational power, and the ability to process data at an unprecedented rate, data-driven models have become an undeniable and extremely powerful method of choice for understanding and predicting different phenomena⁶⁴⁻⁶⁶. Over the past few years, there has been an increasing interest in using Machine Learning (ML) algorithms to harness the power of data-driven modelling in all avenues of science and engineering. However, the field of soft matter and more specifically rheology is clearly lagging behind, and not capitalizing on such advanced methodologies. This is perhaps in part, due to the ambiguous consequences of the produced meta-models, and more importantly their correlations to the fundamental underlying physics that drive a particular phenomenon. However, these issues can be efficiently alleviated by devising the appropriate type of ML approach that is guided or informed by the physical laws of interest. Bishop⁶⁷ defined ML as a subset of Artificial Intelligence (AI) that performs a specific task without using explicit instructions. The types of ML algorithms differ in their approach, the type of input and output data, and the type of task or problem that they intend to solve. Neural Network (NN) is a type of supervised⁶⁸ ML algorithm that is inspired by the biological neurons system to process and predict data. NNs consist of many interconnected processing elements called neurons that work together to model a computational structured framework where the complex relations between the inputs and outputs is revealed as a function. These networks are capable of learning such functions, and the system learns to correct its own errors by working the weights and inferences between these functions. Learning in NNs is adaptive, which means the weights of the neurons are changed continuously to generate a correct response when new inputs are provided. Over the years, different types of NNs were introduced namely those of Artificial Neural Network (ANN)⁶⁹⁻⁷⁵, Deep Neural Network (DNN)⁷⁶⁻⁷⁹, Convolutional Neural Network (CNNs)⁸⁰⁻⁸² and Recurrent Neural Network (RNNs)^{83,84}. Each of these NNs have proven to be effective for a variety of physical applications. Regardless of the type of NNs, or as a more general category ML algorithms, these methodologies rely on abundance of data to maintain a reliable and accurate predictive ability. In other words, it is absolutely essential for the NNs to be trained on exhaustively large data sets to enable any reliable predictions. Another setback for the ML and data-driven algorithms in scientific applications is the fact that ML algorithms are generally limited to predictions in the range of training data sets. In other words, given that sufficiently large training data sets are employed, data-driven models can only predict outputs for the input conditions that fall in the range of training data (interpolation), and are not able to predict beyond this range (extrapolation). Furthermore, the underlying physics is non-existent in ML algorithms, since the basic idea behind every ML algorithm is predicting based on data correlations and statistics. Therefore, there has been an increasing attention to developing methods for reducing the need for large data sets, as well as including the essential physics of a given problem into the NN. The pioneering work of Raissi, Perdikaris, and Karniadakis⁸⁵ introduced a novel concept called “Physics-Informed Neural Network” (PINN) to address these issues. The idea behind such networks is to add physical governing equations to the NN framework to achieve a meaningful meta-model. By introducing the essential physics of the problem, and conditioning the NN correlations to always adhere to these physical laws, the need for large training data sets is diminished, and physical problems can be solved with fewer number of observations in a data set. Subsequently, a number of variations to original PINN for solving different problems have been introduced: Parareal Physics Informed Neural Network (PPINN)⁸⁶ for parallel in time learning of a problem, Multi-fidelity Physics Informed Neural Network (MPINN)⁸⁷ for solving problems in which the training data exists with varying level of confidence, fractional Physics Informed Neural Network (fPINN)⁸⁸ for solving fractional partial differential equations, and other methods such as nonlocal Physics-Informed Neural Networks (nPINN)⁸⁹, DeepONet⁹⁰, and DeepXDE⁹¹. It should be noted that PINNs are not the only physics-based approach for data-driven and ML. For instance, Wang, Wu, and Xiao⁹² introduced a physics-informed machine learning approach to reconstruct the Reynolds stress discrepancies in RANS modeling using DNS data. A framework based on the physics-informed machine learning approach was designed by Wu, Xiao, and Paterson⁹³ to augment the turbulent models. Swischuk et al.⁹⁴ introduced a parametric surrogate model that develops a low-dimensional parametrization of quantities of interest, such as pressure and temperature, using proper orthogonal decomposition (POD). By incorporating these parameters into the machine learning algorithm, the methodology learns to map the input parameters to the POD expansion coefficients and predict a high dimensional output problem. Jia et al.⁹⁵ presented physics- guided machine learning to predict and simulate the temperature profile of a lake. Rackauckas et al.⁹⁶ introduced a Universal Differential Equation (UDE) framework as a scientific machine learning framework that can be used in a range of different problems such as discovering unknown governing equations and accurate extrapolations.

As discussed above, there are various methods of incorporating the essential physics into different ML algorithms. In the case of neural networks, the physical governing laws can be included implicitly or explicitly. Explicit inclusion of physics in form of differential equations is proven to be very efficient in accelerating solution of problems with known constitutive models. On the other hand, implicit inclusion of physics can be more effective when the physical laws that govern the phenomena are not particularly accurate. In this work, we present an implicit methodology for incorporation of physical governing laws, referred to as multi-fidelity NN (MFNN), to construct a rheological meta-model for predicting the quasi steady-state simple shear rheological response of a complex multi-component system. Moreover, we seek to determine the applicability of the physics-based neural networks on predicting the rheology of a complex fluid with respect to more complex parameters such as aging, salinity of the mixture, temperature dependence, etc. The goal of the current work is to establish the framework that will preserve the essential physical and rheological underpinning of the problem, and by doing so enables accurate predictions of rheological response of a given complex multi-component system.

Thus, the architecture of the current study is as follows: Section II A provides information about the material system as well as the experiments performed and type of data at hand, section II B presents the detailed information about the Multi-Fidelity Neural Network (MFNN) as well as the simple deep neural network (DNN) and their corresponding structures, section III compares the predictions made using the proposed method, DNN, and a material specific constitutive equation with respect to the steady flow curves of the material under simple shear. Finally, section IV provides concluding remarks as well as an outlook for future data-driven frameworks in rheology.

### II. Problem Setup and Methodology

### A. Material and Experimental Methods

The material used in the current study is a model fluid formulated to mimic the complexity of consumer product formulations. The model system investigated consists of several components: a surfactant continuous phase, formulated to self-assemble into entangled worm like micelles (WLMs), different types of colloidal particles, polymer, oil additive, and in some samples model perfume. Table I presents the full variability and the range of variations for each component in different samples, named samples 1 through 19. In these systems, due to the presence of wormlike micelles and the polymers, the colloidal particles self-assemble into a network driven by the depletion attraction forces^{97,98} and form a colloidal gel with a measurable yield stress. The surfactant continuous phase present in the system exhibit the typical rate dependent viscosity found in worm like micellar systems, with shear-thinning behavior above a critical shear rate, due to the alignment of worm like micelles under shear. On the other hand, the gel network formed by the colloids break apart under flowing conditions, resulting in a different shear thinning mechanism. The coupling of two phenomena, as well as presence of other particles result in a rather complex response even under steady shear flows. The steady state flow curve is found to be described rather accurately using a combined TC model in which the Newtonian term is replaced by Carreau model to account for the nonlinear rheological behavior of the continuous phase. The exponent of the Carreau model is fixed to 1 to describe the presence of a stress plateau in the shear thinning region of worm like micelles. Equation 5 represents this material-specific model referred to as TCC model in the manuscript.)

σ=σ_{y}+σ_{y}(\dot{γ}/\dot{γ}_{c}_{_{TC}})^{0.5}+\dot{γ}k(1+(\dot{γ}/\dot{γ}_{c}_{_{carreau}})²)^{-0.5} (5)

Evidently, the TCC model has four different fitting parameters, but each one has a clear physical meaning allowing to set expectation and boundaries that will limit the space of possible flow curves that such complex formulated system can express. Nonetheless, these parameters do not offer a mathematical expression that directly reflects on the formulation of the fluid, its age, or a clear correlation to experiment temperature.

### B. Neural Network

### 1. Deep Neural Network

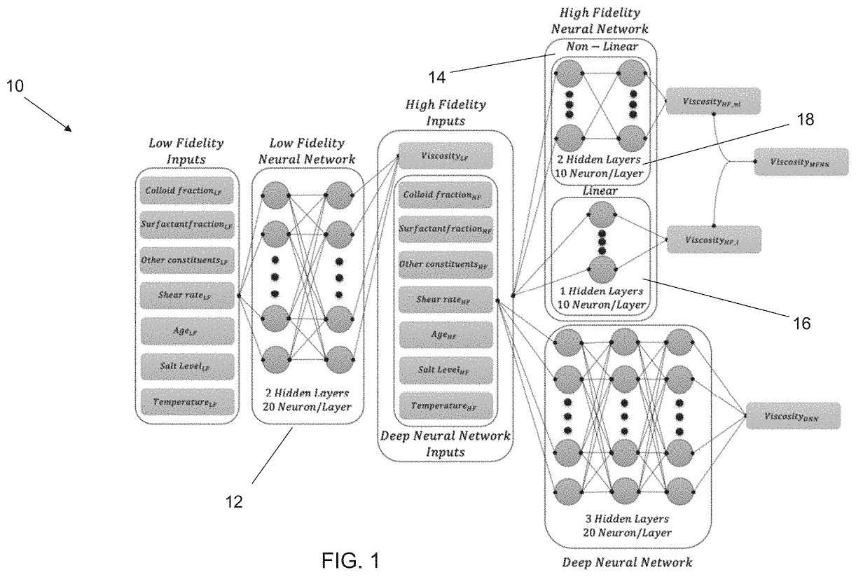

NNs are a subset of ML algorithms that can be employed to predict the output responses of a complex system. Each NN consists of several hidden layers, and each hidden layer contains several neurons. Typically, a NN with more than 2 hidden layers is called Deep Neural Network (DNN). The bottom right architecture presented in FIG. 1 shows a schematic view of a DNN with 7 inputs and 1 output. As clearly named across colored boxes in the figure, the inputs to the DNN in our study are the different constituents of the model fluid, the imposed deformation rate, the age, the salt concentration in the background fluid, and the experiment temperature. These parameters are then correlated to a single output, shear viscosity, using a number of layers and neurons. For visual purposes the figure presented only includes three (3) hidden layers, with several neurons per layer shown. In practice this number was also varied and the sensitivity of predictions to number of these layers and neurons are later discussed. Variables in a DNN can be learned by minimizing the loss function according to equation 6.

MSE=Σ(y_{actual}−y_{predicted})² (6)

In equation 6, MSE is the loss function, y-actual is the real result and y-predicted is the NN predicted result. The NN operates in a manner to minimize the MSE by changing the weights and inferences between each layer/neuron to next. By adjusting these variables in a NN, a meta-model is produced to predict the output based on a new input variable. As evident in FIG. 1, this methodology solely relies on data points and correlations between them, and does not adhere to any physical laws.

### 2. Multi-Fidelity Neural Network

Here, we introduce a novel method to leverage NN capabilities to incorporate a rheological-basis for data-driven modeling and prediction of experimental results. To do so, we are introducing a Multi-Fidelity Neural Network (MFNN) framework leveraging advances in physics-based NNs with limited number of actual data at hand. As mentioned before, there exists several methods to incorporate the essential physics of a problem into the NN. Here, we include the physical law by means of low-fidelity data generation from a given physical model. It is important to note that in this framework, high-fidelity data are referred to any experimental or high-resolution simulation result that is reliably reflecting on the rheological behavior. These high-fidelity data are commonly expensive (with respect to time and resources) and exist in limited quantities. With a limited number of high-fidelity data, comes a very limited understanding of the problem as well. In this methodology, low-fidelity data are generated by introducing noise into different constitutive models, and synthetically generating an abundance of data. However, it should be noted that the low-fidelity data sets are not reliable for optimization purposes, and can only be used in conjunction with the high-fidelity data sets. By controlling the constitutive equation of choice adapted for low-fidelity data generation, we investigate the role of underlying physics. Ultimately, a combination of low- and high-fidelity data sets should be utilized for an appropriate physical understanding and accurate optimization. For an introduction to multi-fidelity modeling please refer to Fernandez-Godino et al.⁹⁹. The simplest relation between low- and high-fidelity data can be expressed as equation 7, in which y_{HF} and y_{LF} are high-fidelity and low-fidelity data respectively⁹⁹. In addition, ρ(x) and δ(x) are multiplicative correlation and additive correlation surrogates, accordingly.

y_{HF}=ρ(x)y_{LF}+δ(x) (7)

Equation 7 expresses linear correlation in multi-fidelity modeling. However, the correlation between low- and high-fidelity data do not obey equation 7 in most problems, hence, a general expression to reveal the correlation of low- and high-fidelity data is needed. The general form of equation 7 can be written as equation 8, in which G () is a general combination of y_{LF} and x.

y_{HF}= [symbol] (y_{LF},x) (8)

In addition, decomposition of the general correlation into linear and non-linear parts is shown in equation 9.

y_{HF}= [symbol] ₙₗ(y_{LF},x)+ [symbol] (y_{LF},x) (9)

FIG. 1 shows a schematic of an exemplary Multi-Fidelity Neural Network (MFNN) 10 in accordance with one or more embodiments. A MFNN comprises two interconnected Neural Networks: the first NN 12 handles the low-fidelity dataset, and the second NN 14 deals with the high-fidelity data coming from experiments. The high-fidelity part of a MFNN, contains a “linear” part 16 and a “non-linear” part 18 as discussed in equation 9. Each part on high-fidelity NN learns the correlation between the output and input data using its own network of layers and neurons⁸⁷. The left architecture presented in FIG. 1 show the schematic views of the low fidelity NN 12 with 7 inputs and 1 output. The top right architecture labeled as the high-fidelity neural network 14 shows the 8 input parameters (the seven inputs to other two NNs, as well as the viscosity output from the low-fidelity NN) of the high-fidelity platform. Also clearly named across colored boxes in the figure are the inputs to both NNs in our study. For visual purposes the figure presented only includes two hidden layers for the low-fidelity NN 12 and the non-linear part 16 of the high-fidelity NN 14, and a single hidden layer used in the linear part 16 of the high fidelity NN 14. In practice this number was also varied and the sensitivity of predictions to number of these layers and neurons were studied. The variables of a MFNN are learned by minimizing the loss function according to equation 10.

MSE=MSE_{y}_{_{HP}}+MSE_{y}_{_{LF}}+λΣwᵢ² (10)

In equation 10, MSE_{yHF} and MSE_{yLF} are deviations of predicted and actual data for high- and low-fidelity data, respectively. Also, wi are the weight functions for the NNs and λ is L₂ regularization rates for weight functions to prevent over-fitting¹⁰⁰. MFNN can benefit from the accuracy of the high-fidelity dataset as well as the abundance of the low-fidelity dataset, to predict a suitable output based on input variables. The idea is to use the low-fidelity NN to provide trends to the high-fidelity NN, since the number of high-fidelity data is much smaller in comparison. In addition, the low-fidelity NN prevents the high-fidelity NN from diverging off the correct solution.

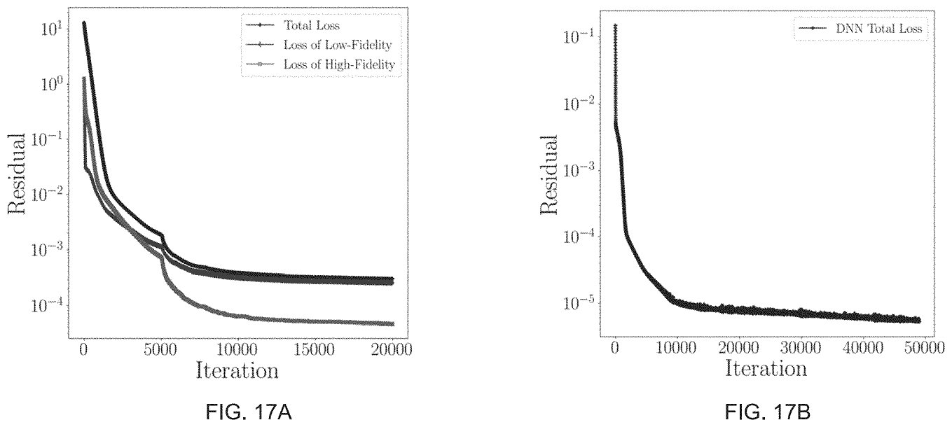

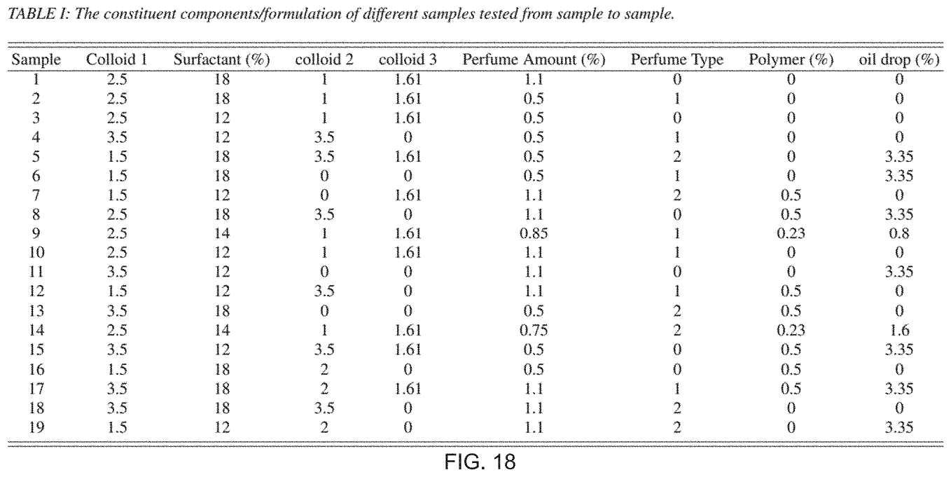

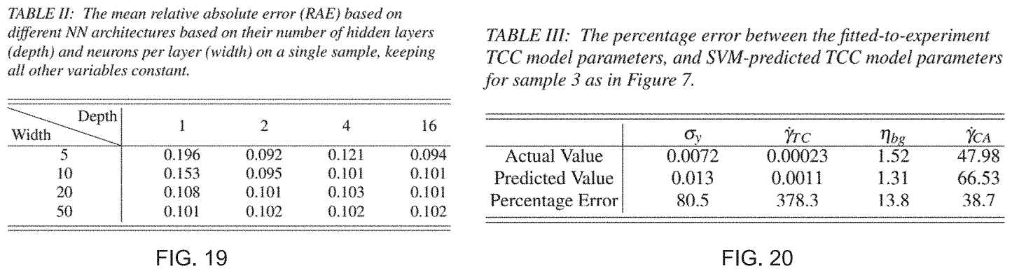

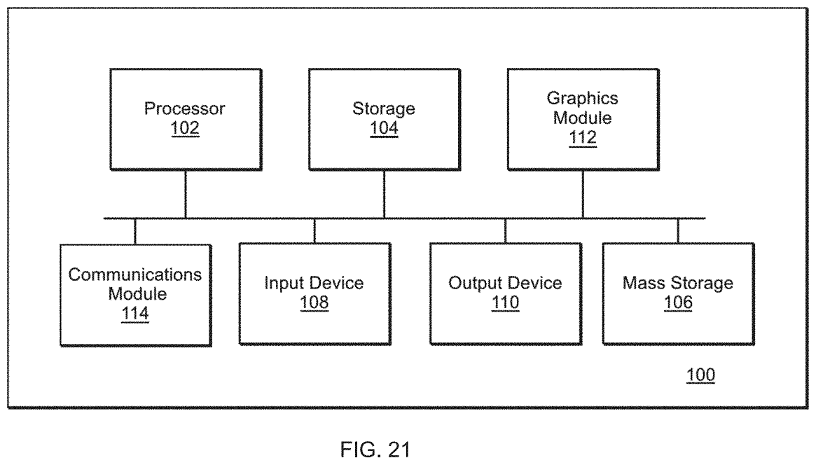

For details of convergence comparison between the DNN and the MFNN architectures, and the residual losses corresponding to each method, refer to FIG. 17 of the Appendix.

### 3. Effect of NN Architecture on Predictions

An important aspect of the NN algorithms that has been studied extensively^{85,87,101} is their architecture. Namely, the number of layers within the NN architecture, and the number of neurons per layer can affect the accuracy of the NNs with different architectures. To this end, we use the Relative Absolute Error (RAE) according to equation 11 as the measure of accuracy to compare the role of the number of hidden layers (Depth) and the number of neurons per layer (Width).

$$RAE = \frac{1}{N} {\sum }_{n = 1}^{N} \frac{\vert {y}_{actual} - {y}_{predicted} \vert}{{y}_{actual}} \qquad ( 11 )$$

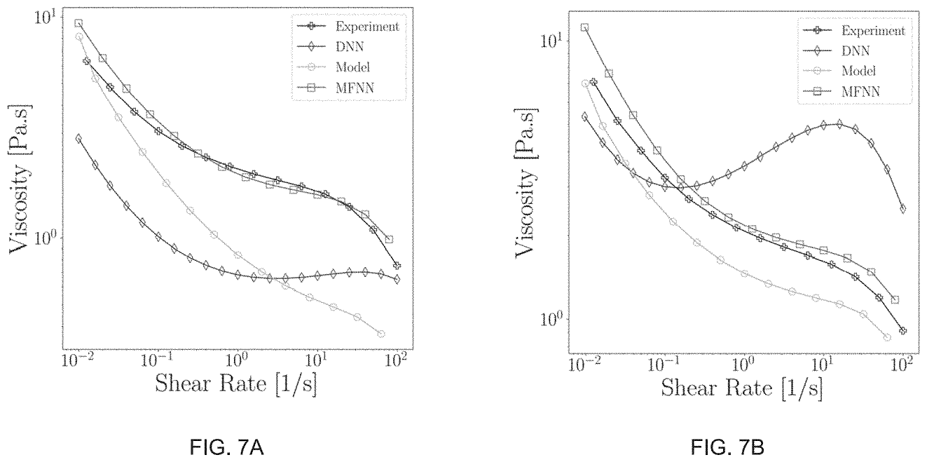

All calculations are done based on a predictive MFNN for the same sample to exclude system specific biases. Increasing the number of hidden layers as well as the neurons in each layer adds complexity to the NNs and expectedly the accuracy of the NNs change. Nonetheless, increasing the NN elements does not necessarily result in increasing the accuracy of its predictions. Adding more neurons to the NN can lead to over-fitting, which in turn reduced the efficiency of the algorithm. Table II shows the relative error of different NN architectures, namely the DNN and the MFNN algorithms, in predicting the steady state shear viscosity of a sample based on its constituting components. The specifics of the results are later presented and discussed in FIG. 7. In this study, widths ranging between 5 and 20, and depths ranging between 2 and 4 are found to yield the best levels of accuracy to avoid over-fitting.

### 4. Training Data Set

The training dataset contains the quasi-steady shear viscosity behavior of 19 different sample compositions over a range of shear rates between 0.01 s⁻¹ and 100 s⁻¹ (42 different shear rate points). In order to evaluate the ability of the MFNN and the DNN algorithms, in each section the networks are trained on 18 (of 19 total) samples' experimental data, and asked to make predictions for the 19th sample. In our study, all 19 samples have been systematically tried and tested; however, for the sake of brevity in each section results for two different samples are presented. These do not represent the best or worst performances of the neural networks, and are merely two different examples to ensure robustness of the methodology. Thus, throughout the application, the term “prediction” is referred to NN's predicted results for a sample or a parameter choice that was removed from the training data sets. In order to determine the importance of each constituent in the sample on the rheological behavior, a sensitivity analysis was performed, which indicated that the shear viscosity is strictly sensitive to one of the colloids (18% sensitive) and the surfactant amount (16% sensitive) amongst all constituents of the system. Nonetheless, while relatively smaller than the two-component mentioned, the amount of remaining components also affects the viscosity (between 6% and 9% percent). In an ideal situation, where a wide variety of experimental data exists on each of these components, one would define each of them as an input to the DNN and MFNN to enable the most accurate predictions; however, since only a very limited number of samples are at hand, all of the remaining parameters are clustered into a virtual category reflecting on sum of these components' compositions. Collectively, the colloid fraction, the surfactant fraction, this new parameter (all other fractions combined) as well as the shear rate are the three state variables that are set as direct inputs to the NNs. In practice three different concentrations of salts are later added to the system in order to adjust the background viscosity (at the shear rate of 10 s⁻¹) to 1, 5 and 10 Pa·s respectively. Samples are also stored for different times and tested in 1-month intervals to study the rheology of aged materials. This testing however is performed at two different temperatures (25 and 40 degrees centigrade). Thus, in addition to the three state variables, the imposed shear rate, the salt concentration, the experiment temperature and the age of the sample are other direct inputs to the NNs. These seven (7) different input parameters are then correlated to a single output in both DNN and MFNN, which is the steady state shear viscosity of the fluid.

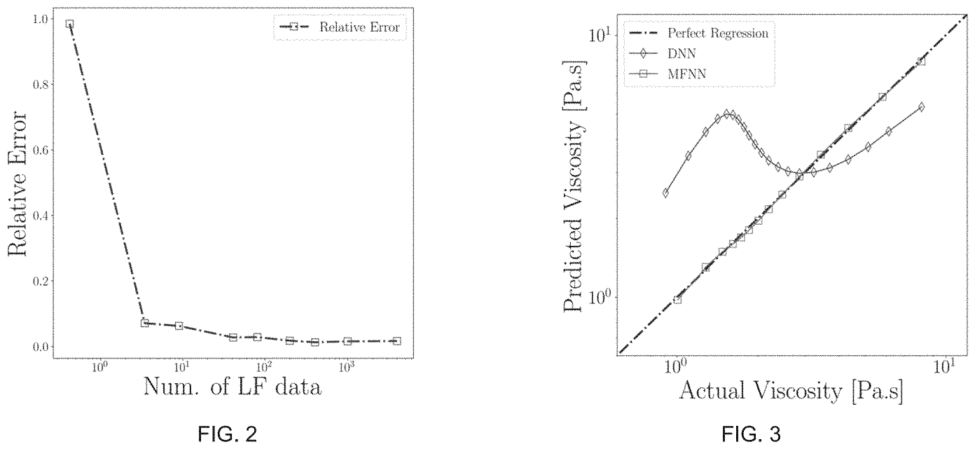

The training data set described above constructs the input parameters and data for the DNN as well as the high-fidelity portion of the MFNN architecture. As noted previously, the low-fidelity data of the MFNN algorithm are generated based on physical constitutive equation. This allow for the role of physics to be studied directly by changing the constitutive model employed to generate the data. This is of utmost importance, as the choice of the model used directly dictates the physical intuition of the NN. For instance, if the material under investigation exhibits a yield stress under experimental conditions, the physical model of choice should also have a yield stress description. Later, we will present the effect of such physical choices on the ability of the MFNN platform to capture the rheological behavior. The number of low-fidelity data is chosen in a way that the absolute relative error based on equation 11 is not dependent on the amount of data. FIG. 2 shows the variation of relative error with respect to the number of low-fidelity data (for the same case study as in Table II, and FIG. 7). For all subsequent results presented in this current study, we generate 10 low-fidelity data points for each high-fidelity data point at hand.

### III. Results and Discussion

A goal of the present work is to establish the framework in which a ML algorithm, namely a physics-informed neural network can be developed and employed as an alternative meta-constitutive model. Thus, we first present the predictions made using such framework for the steady-state shear viscosity of a complex fluid, using a DNN, a MFNN and a constitutive model developed specific to the material under investigation. Subsequently, we investigate the applicability of our proposed methodologies to predict the shear viscosity of the material with respect to the role of aging, temperature, and addition of salt which are not reflected through the TCC model shown in equation 5.

It should be noted that results predicted by the DNN platform do not contain any physical intuition, and are merely data-driven predictions made based on other material compositions. However, in MFNN method, the underlying physics of the problem manifest in the form of LF data generated, and thus predictions made using MFNN directly reflect on the choice of model and complexity of the physical laws that LF data adhere to. Hence, having developed the MFNNs of choice, there are several different pathways for actual utilization of these networks: 1) When the HF data of a given material are available, as well as the material-specific constitutive equation that explains those data (in this case, the TCC equation). In this situation, the MFNN predictions are simply compared to model fitting as an alternative. Here we refer to these predictions as “interpolation” as the parameters of a working constitutive model are known. 2) While the TCC model accurately explains the steady shear rheology of these fluids, it is strictly limited to this material and components. However, realistically it is likely that the experimental data (HF) are available, but the more familiar constitutive equations such as Herschel-Bulkly model, Power-Law model, etc. are unable to capture the non-trivial rheological behavior of the material. In such instances, the MFNN can be employed as an evolving meta-model, where minimal physics are presumed for the physical law that informs the NN, in order to provide the best possible prediction of the rheological behavior. As such, the MFNN is informed by well-known preexisting models such as simple power-law, or a Herschel-Bulkley, which are known to be not accurate in describing the actual rheology, but are used as the most basic presumptions for the behavior of the material. 3) In product/material design and development, often the typical experimental data and working constitutive equations that explain those data are available; however, the model does not necessarily correlate to each individual component of the fluid and thus it cannot predict the rheology based on the formulation of a new material. For instance, in the case of our multi-component fluid, what would an entirely new formulation in terms of surfactant or colloidal fraction entail in terms of rheological behavior? In order to answer this using traditional constitutive models, a priori functional form for the relationship between different model parameters and the material components is required. Otherwise for any new composition/combination of material constituents extensive new testing is required. Here we explore the possibility of predicting the rheology of a new sample formulation. In other words, no HF or LF data are available for a new sample, and are solely predicted using the existing data on other material formulations. We refer to these predictions as “extrapolation” as they fall outside the bounds of training data sets. 4) Since the TCC model parameters do not explicitly reflect on the temperature-, salt concentration- or age-dependent rheology of the material, no theoretical prediction based on the constitutive model is possible for the rheology of an aged formulation or a formulation at elevated temperatures. Hence, we investigate the applicability of the proposed method with respect to different sample age, salinity and temperature-dependency of the fluid. In other words, here we seek to alternatively use NNs to answer this question: “how does change in temperature/salinity/sample age affect the bulk rheology of a multi-component colloidal gel-WLM mixture?”

### A. Interpolation

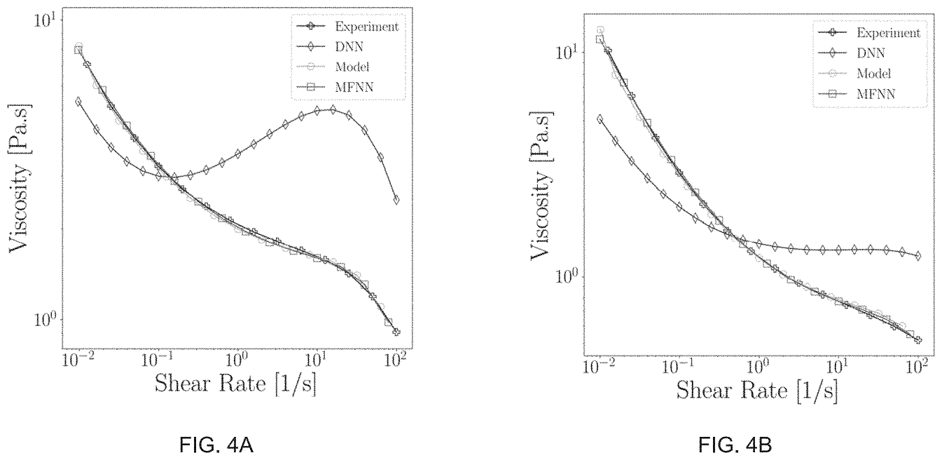

In interpolating (and fitting) of the shear viscosity of this material system, for each of the samples the actual experimental data and the coefficients of the TCC model that describe those data are known. Thus, the LF data points are generated using the appropriate physical constitutive model of choice for each given sample. It should be noted that the actual HF data are only used to fit the TCC model, and generate the LF data using the model parameters, but are eliminated from the HF training data set. For the simple DNN, the training data set includes the information of all other compositions except the targeted sample. The regression plot of the trained model for a sample is shown in FIG. 3. It should also be noted that the performances of the DNN and the MFNN are found to be highly typical and not dependent on specific samples. In other words, the results presented in FIG. 3 do not represent the best or the worst performances of the MFNN/DNN and are merely chosen as comparison points. Evidently, the MFNN tracks the experimental data (HF) very closely, with minimal deviation, while the DNN fails to recover the monotonic changes of the viscosity. This confirms that the MFNN platform, by incorporating the LF data using the appropriate TCC model parameters inherently captures the details of rheological features of a given sample. On the other hand, strong deviations between the predicted and actual viscosities for the DNN shows that at least using the limited number of actual data points available for these samples, a purely data-driven prediction cannot reflect on any rheological features of the system. Alternatively, one can plot the predicted flow curves instead, which are shown in FIG. 4. One would argue that the inability of the DNN will diminish as the number of data points at hand increases. Nonetheless, it is not likely to have an abundance of experimental data for a given rheological behavior, similar to data sizes commonly observed in other applications of deep neural networks. The results from MFNN on the other hand accurately track the experimental observations. We note that the model predictions provided in FIG. 4 are the results of the constitutive equation based on equation 5 and are the basis for LF data generation in MFNN. As evident in FIG. 4, the MFNN here does not offer any improvement over the constitutive model at hand. Thus, one could argue that when model parameters are known for a constitutive model, the data-driven approach simply recovers the same results using the LF data that are very accurately describing the rheology.

### B. Role of Physics

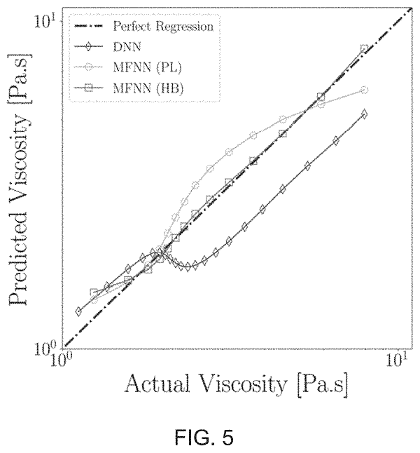

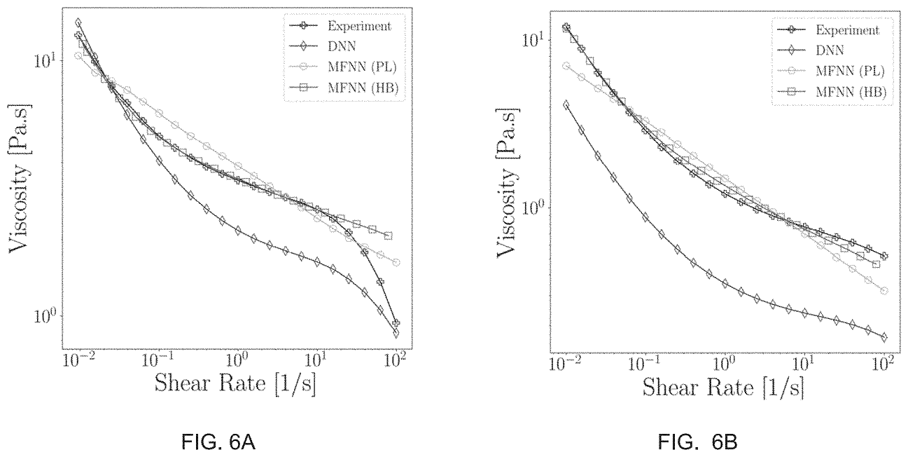

As previously mentioned, the underlying physical laws that govern the rheology and dynamics of a complex fluid can be represented in various mathematical forms. With respect to a multi-component structured fluid under flow, representing this behavior in a singular closed form equation (as in TCC model) is far from trivial. Thus, one would initially use classical models to explain and describe a certain behavior, before developing system-specific equations that require timely and expensive rheological interrogation of the material under different flowing conditions. On the other hand, results in FIG. 4 clearly show that inclusion of the underlying physics into the NN is essential in enabling the algorithm to provide an accurate prediction. In this section we investigate the role of the accuracy of this physical intuition in recovering the rheology of our fluid. In other words, we are seeking the answer to this question: what if the ideal constitutive model of choice is not known for a given material? In the first step, instead of the system-specific TCC model, we use classical constitutive equations with different levels of complexity (and hence fitting parameters) to generate the low-fidelity data. Namely, PL and HB models with respectively two and three fitting parameters are used in generating the low fidelity data sets. The material under investigation shows a yield stress, two different shear thinning regimes and exponents, and a short plateau viscosity in the intermediate shear rate regime. It is clear that a simple power-law model, which only predicts a single thinning behavior is unable to capture such viscosity changes. Nonetheless, the goal here is to interrogate MFNN's ability to predict shear viscosity with such a primitive physical intuition. The generated low-fidelity data sets as well as the acquired high-fidelity data sets of other samples (excluding the sample under question) are employed to train the MFNN. In order to provide a benchmark against the classical DNN algorithms, results are also presented using DNN with no physical intuition. The regression plots for both the classical DNN and MFNNs using different physics are shown in FIG. 5. While the classical DNN does not seem to predict the actual experiment, by incorporating minimal physics into the problem using the PL model, the regression is ameliorated. Further Similar to results in FIG. 4, one can output a fully recovered flow curve of the target sample using DNN and the MFNNs described above shown in FIG. 6. While simple DNN does not follow the experimental data accurately, even the simplest and most primitive physical model (PL) appears to provide a rather general trend of the range of viscosities observed. In this framework, since the number of LF data points significantly overweigh the number of available HF data points, the shape of fitting and general trends of the viscosity are governed by the physical equation used, while ranges and values are corrected through HF experimental values. Thus, using a simple PL model does not provide the flexibility required to capture the complexity of the viscosity behavior. Nonetheless, an incrementally more complex model such as HB satisfactorily captures these complexities and decreases the mean deviation between MFNN-HB fitting predictions and the actual experimental data to less than 1%. This observation is significant with respect to predictions made by the MFNN model, as it suggests that the MFNN outperforms the pure constitutive model, as well as the pure data-driven model in the absence of ideal models that explain the rheology. In fact, such perfect constitutive models do not exist for most complex fluids. For instance, even a complex Fractal Iso-Kinematic Hardening (FIKH), or Thixotropic-Elasto-Visco-Plastic (TEVP) with more than 10-15 fitting parameters cannot accurately recover the time- and rate-dependent rheology of a multi-component crude oil. In such situations, and considering the cost of parameterizing the model for a new sample or flow protocol, the MFNN offers a significant leap in predicting the rich rheology of the fluid using what is known to be the correct but non-trivial physical model.

### C. Prediction (Extrapolation)

As previously discussed, constitutive models (regardless of their ability to describe a set of experimentally measured rheological behavior) commonly lack predictive abilities for new formulations. This is due to the fact that all constitutive modeling approaches are reduced-order models, in which state variables and material components/compositions are represented collectively through a number of model parameters. Since in a multi-component system, changing the fraction of one can change the interactions between others, such simplistic representation of material parameters takes away any predictive abilities. In contrast, NNs do not reduce the order of the problem at hand, and each component and its variations can be direct inputs, with non-trivial correlations made through the hidden layers and neurons to the output viscosity. Here, we evaluate the ability of DNN and MFNN algorithms in predicting the rheological behavior of a new formulation. Thus, the results presented in this section are pure predictions of the NNs for a composition of the model fluid. To do so, the experimental data for all samples but the one under question are available to the NN for training, as well as a model that accurately describes those behavior. Nevertheless, the model parameters in generating LF data points for the new formulation are unknown as well and have to be estimated and predicted. This is similar to realistic material development in which the only known information of a newly developed sample are its components and their compositions. In other words, the MFNN results presented here are complete predictions of the viscosity behavior of a given sample, solely based on the TCC constitutive equation through which the material's behavior can be explained, and not its actual model parameters. The TCC model has four main fitting parameters with no particular functional form that correlate to the composition/formulation of the material. For instance, there is no clear connection between these parameters and colloid or surfactant concentrations. Hence, in the first step one needs to provide an estimate for each of the four TCC model parameters of a new sample, based on the compositions in other existing samples. In the absence of data-driven method, the most reasonable approach would be to deduce the model parameters by interpolating from existing samples. For instance, if the yield stress for 0.015 and 0.035 fraction of specific colloid is 0.1 and 0.3 Pa respectively, one could simply assume that for the intermediate fraction of 0.025 the yield stress can be approximated around 0.2 Pa. We should note that this is only a logical choice in the absence of a physical underpinning or a functional form that describes the colloid fraction-dependent yield stress of the fluid. In this section, for the “model” predictions, such interpolations are used. The yellow line in FIG. 7 shows the results for interpolation-predicted TCC model, and the red line exhibits the performance of the DNN. Evidently, both the DNN and the predicted model fail to recover the viscosity behavior of a new untested sample.

On the other hand, for the MFNN algorithms the coefficients of the untested sample are predicted via a simple ML algorithm known as Support Vector Machine (SVM). Table III presents the accuracy of the SVM algorithm predictions of the TCC coefficients, compared to actual model parameters from fitting TCC to experimental data. The SVM-predicted TCC model coefficients are used to generate LF data sets, and training the MFNN algorithm. The MFNN algorithm is consequently asked to provide a prediction based on these LF data, and the HF data of other samples to the viscosity of an untested fluid, presented as the green line in FIG. 7. In contrast to DNN and the interpolated TCC model, the MFNN leverages the abundance of LF data in the model, as well as the accuracy of HF data in the DNN. Combining the strength of both methods, the MFNN clearly provides a significantly closer prediction of the actual experimental data without any knowledge of the new sample. As can be seen from FIG. 7, both the general trend and the range of the viscosity are predicted with minimal deviations from their actual values using the MFNN algorithm. Since the physics of the problem and thus the non-monotonic behavior of the viscosity are incorporated through LF data sets and the constitutive mode, the accuracy of the prediction is highly dependent on the number and accuracy of the SVM-predicted TCC model. However, an acceptable level of accuracy—MSE of less than 1%—is achieved with only a very simple coefficient prediction.

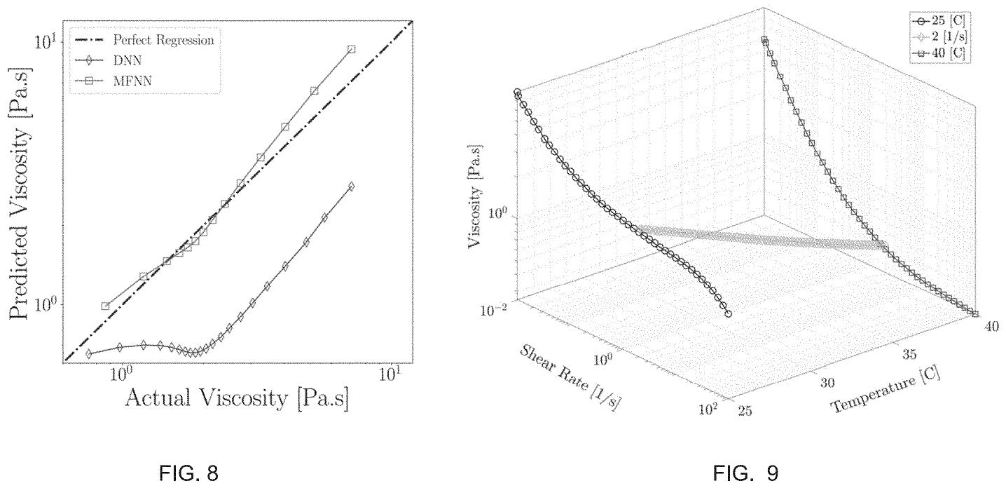

One can argue that in many complex fluids, one can deduce physically-based predictions of the model parameters as opposed to a purely data-driven and interpolation technique such as SVM. The regression plot for the viscosities predicted using the DNN and the MFNN are alternatively shown in FIG. 8 confirming a poor performance obtained using the DNN compared to the MFNN algorithm.

### D. Role of Experiment Temperature

Change of temperature plays an important role on the structure and rheology of our model fluid. Here the experimental protocol is as follows: first, the shear viscosity is probed at different shear rates at room temperature (25° C.), followed by a temperature ramp to 40° C. at a constant deformation rate of 2 s⁻¹, and finally a second flow curve at 40° C. An example of the experimental protocol is shown in FIG. 9.

The fluid studied here is a consumer product, and thus is tested over realistic processing, transportation, storage, and use temperatures. Within those temperatures the fluid does not show any phase transitions in the polymers, colloids or surfactant fractions. Nonetheless, the coarsening of microstructure, interaction between different components, inter-correlation of different constituents and their rate-dependence will be directly affected by changing the temperature. In fact, that is the rational for changed flow curves at elevated temperatures, where the secondary thinning regime is absent.

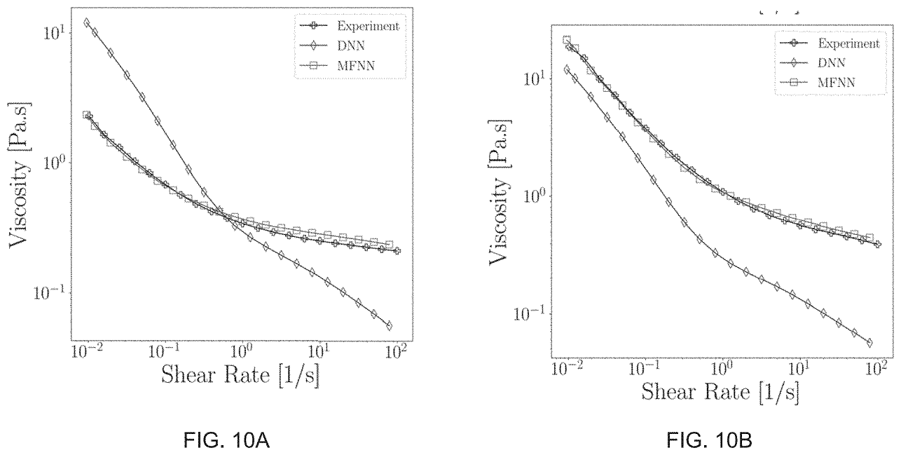

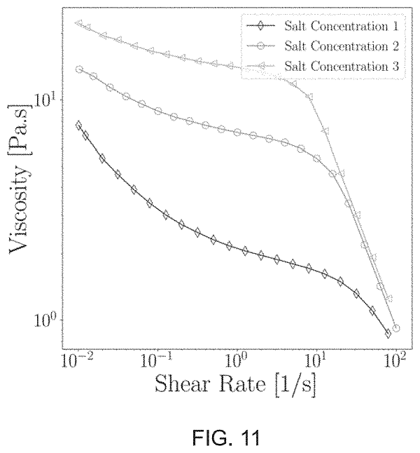

One would argue that while all components individually experience and react to temperature change, the WLMs dramatically change structures at elevated temperatures, resulting in disappearance of the second thinning regime, and a Carreau-like behavior. Consequently, the underlying physics changes by changing the temperature. The simple DNN and MFNN predictions of the viscosities at elevated temperatures for two different samples are provided in FIG. 10. In training these NNs, no information is provided for the elevated temperature flow curves, and the algorithm has been trained on the room temperature viscosity data as well as the temperature ramp at constant shear rate.

As clearly shown through deviations between the DNN predictions and the experimental measurements, the physical in-tuition to the overall rheological behavior is key in providing a meaningful prediction. Thus, the choice of model, and carrying the appropriate form of this physical intuition through low-fidelity data training plays an essential role in enabling MFNN to predict the rheological behavior properly. As previously discussed, the rheological behavior at the 25° C. can be accurately described using the TCC model shown as equation 5; however, by increasing the experiment temperature, the viscosity behavior changes to a typical Herschel-Bulkley or Three Component model behavior, as the Carreau-like behavior diminishes. Thus, for the low fidelity data generation within the MFNN algorithm, a simple Herschel-Bulkley model is adopted instead.

### E. Change of Physics Due to Salt Concentration

The rheology of the model fluid investigated in this study is rather complex owing to a number of structure-forming constituents. Upon formulation, the sample does not contain salt and has a relatively lower viscosity than a target viscosity for practical purposes. Different levels of salt are added to the mixture as viscosity modifiers; however, addition of salt has a dual role on WLMs and colloidal particles. In other words, different levels of salt concentrations are mainly used in practice to set the background plateau viscosity at the intermediate shear rate, by changing the colloidal and surfactant interactions. While these concentrations differ from one sample to another, they are all formulated in a manner to set the viscosity to 1, 5 and 10 Pa·s before the second thinning regime.

One would argue that addition of salt directly changes the effective interactions between the colloidal particles, and the dominant length scale for the WLM structures. The three colloidal particle sizes and variations each have their specific zeta potential, resulting in different phase dynamics for each component under flow as well as in quiescent conditions. Nonetheless, the diverging viscosities (analogue to the yield stress of the fluid) at low shear rates for the samples with different salt concentrations do not show a significant variation. This viscosity increase is even smaller at the highest shear rates explored. This is perhaps due to the fact that at larger shear rates the fluid is effectively destructured and interactions between different components cannot change the macroscopic response of the material. In contrast, the viscosity in the intermediate shear rate regime of 0.1<γ\dot{}<10 increases 10-folds (FIG. 11). This results in a significant change in the shear-thinning behavior observed at intermediate shear rate regime, with minimal changes to the overall viscosity of the fluid at the lower and higher shear rates. Therefore, the viscosity cannot be simply shifted to higher or lower values with the same non-monotonic features as the salt concentration changes. This typical behavior is illustrated in FIG. 11 for a given sample.

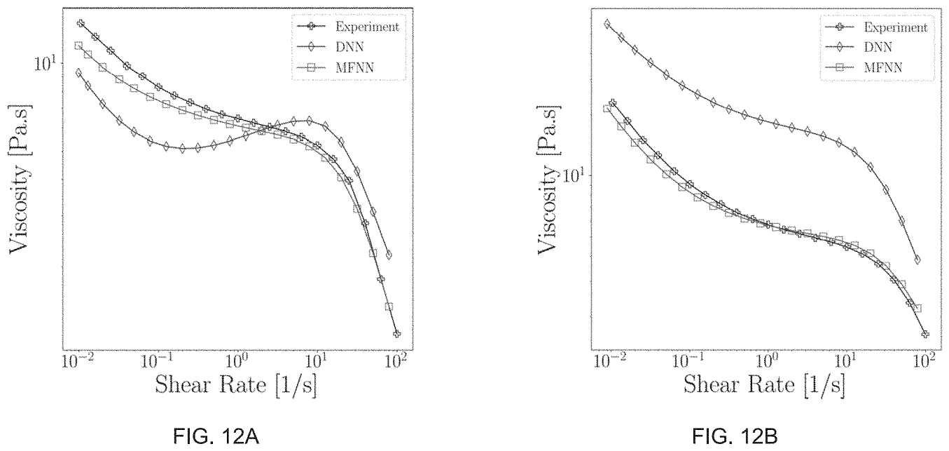

The addition of salt changes the interactions between components of the system beyond any model prediction, which would be only revealed through detailed molecular level simulations. However, as previously discussed, NN-predictions can be made within the range of trained data variables or outside the range of training sets, also referred to as interpolation and extrapolation predictions respectively. Since three different salt concentrations are experimentally investigated, by training the NN on salt concentrations of 1 and 3, and predicting the viscosity at the intermediate salt concentration we probe the interpolation prediction. Once again the simple DNN, despite capturing some features of the flow curves, does not follow the experimental measurements. On the other hand, MFNN for both samples presented in FIG. 12 closely predicts the experiments. It should be noted that the physical law used to generate the low fidelity data remains the hybrid model based on equation 5.

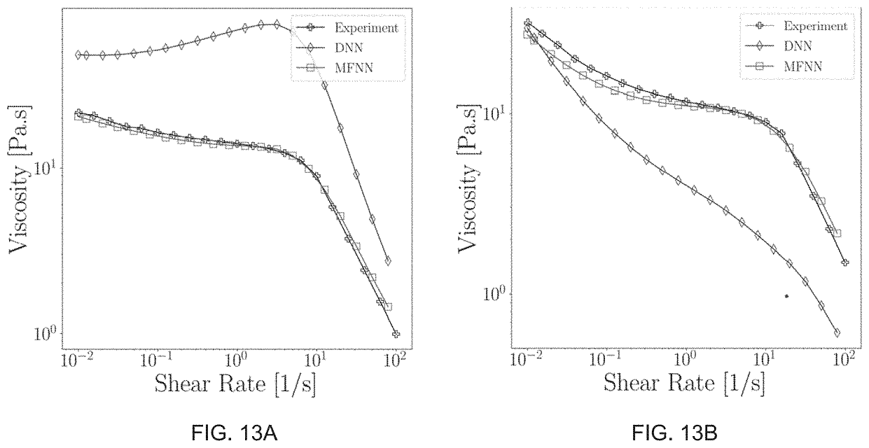

In testing the applicability of MFNN algorithm to extrapolated predictions, FIG. 13 shows the NN viscosity predictions for the highest salt concentration, having been trained on the low and intermediate salt concentrations. The simple DNN shows significant deviations from experimental measurements, as in one of the samples it predicts a shear-thickening in the intermediate shear rate regime, and a steep shear-thinning regime for the other sample shown in FIG. 13. It should be noted that the DNN is purely data-driven and thus the accuracy of its prediction can be improved upon by increasing the number of training data sets. Nonetheless, by introducing the physical instinct through low fidelity data sets, MFNN recovers the experimental measurements with an excellent agreement.

### F. Effect of Aging

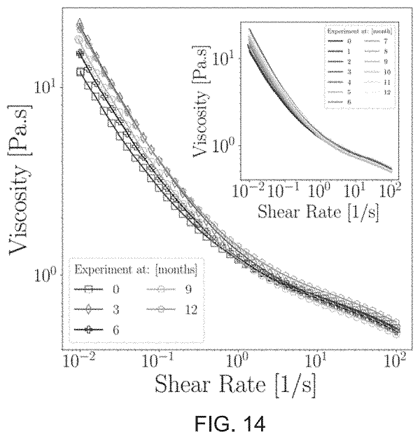

Of particular interest in practical real-world applications, is the ability to predict the behavior of a given material at different times. For this consumer product, such age-dependent rheology directly determines the shelf-life of the material. The structural aging of the colloidal gels and WLMs is a well-studied field of research. Due to dynamical and many-body nature of the particle interactions in each constituent, these micro- and meso-structures coarsen and change over very long timescales resulting in gradual change of rheological behavior as the sample ages. FIG. 14 shows a typical change of viscosity behavior of a given sample over the time period of a year. As clearly indicated in FIG. 14, this behavior is non-monotonic, with increasing the yield stress of the fluid over time and decrease of the terminal viscosity at high deformation rates, making it challenging to capture through simplistic constitutive models.

In practice, and in order to study the role of aging in rheology, one needs to wait for long periods of time to be able to measure the samples with different ages. Alternatively, one can leverage the accelerated aging at elevated temperatures (due to increased thermal motion of particles); however, as discussed previously the temperature change plays a dual role in changing the underlying physics. Here we make predictions of the viscosity behavior at various aging times using the devised NNs, and validate the applicability of such methodologies by comparing these predictions to experimentally measured rheological data. This is done in two different ways: (i) predicting the age-dependent viscosity of a sample, having its rheology at younger ages, and (2) predicting the age-dependent viscosity behavior of an entirely new sample knowing age-dependence of other samples.

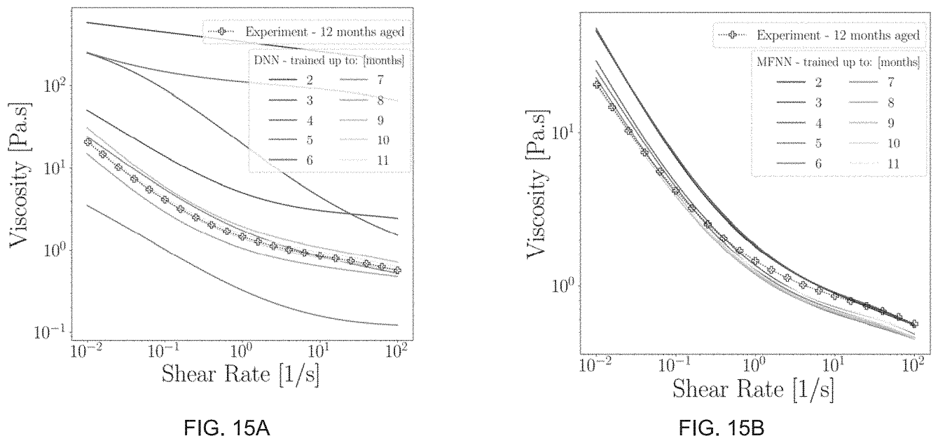

For the first approach, we train the NNs using the same sample's rheological measurements at different times, and make predictions of the viscosity at a specific time. Since several data points for each sample's age-dependent rheology are available, we showcase the applicability of NNs by predicting the oldest sample's rheology using previous history of the fluid. Thus, different NNs are used to predict the rheology of the sample after 12 months of aging, we seek to answer the question of: how many data points are required to provide a reasonable prediction of the viscosity behavior after a year? The result for the experiments after a year, and predictions made using DNN and MFNN are shown in FIG. 15. The legends and the color increments in the figure correspond to different training sets provided, before making predictions of the year-old sample. Evidently, having the full history of the sample at different ages, both the DNN and the MFNN algorithms accurately capture the experimental viscosities observed. Nonetheless, the DNN algorithm does not provide a meaningful prediction before having at least 7 months of rheology data, as opposed to MFNN which provides a very good prediction of the viscosity behavior having only the behavior of the fresh sample and after one month of aging. Since the underlying physics of the problem does not change over time, the low-fidelity data sets are generated based on the TCC model. However, the coefficients and TCC model parameters for the viscosity behavior of the unknown age are predicted using the coefficients of available months. These predictions (for the model parameters) are made using a simple ML algorithm, Moving Weighted Average (MWA) and a linear regression. By using the predicted coefficients, a number of low-fidelity data are generated to train the NN.

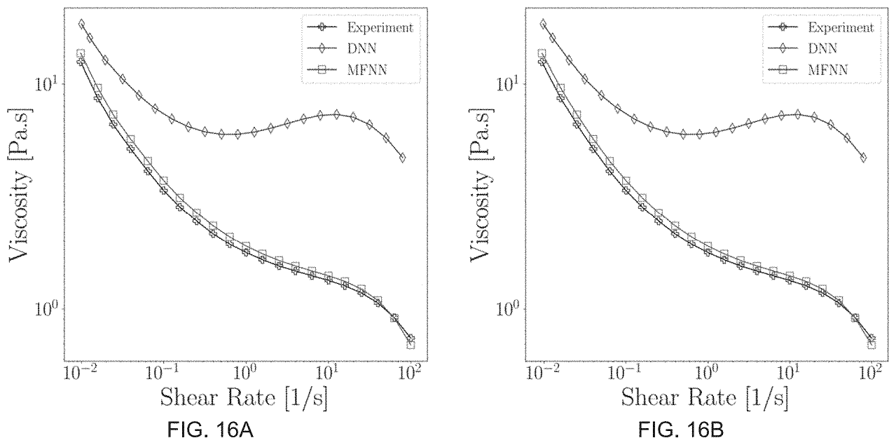

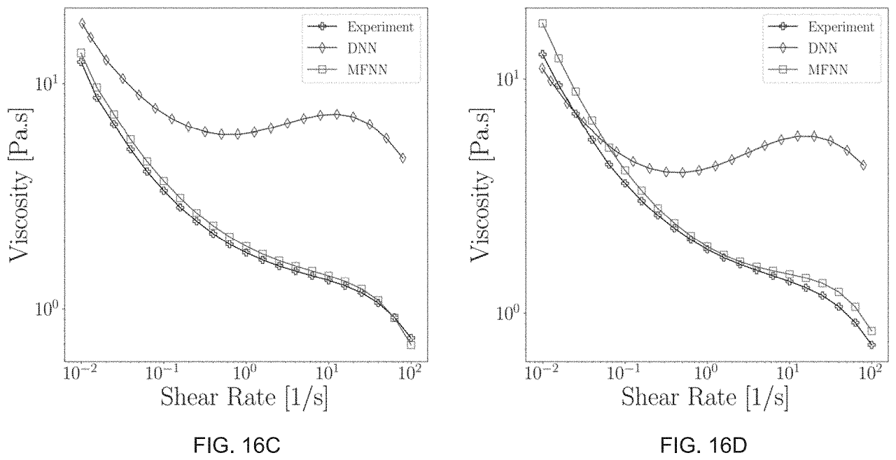

For the second scenario, we train the NNs on the rate-dependent rheology of all samples at all ages at hand, and seek to predict the viscosity of an entirely new sample based on its components at different ages. This is of particular interest in industrial settings, where new formulations are devised regularly and a prediction on the long-time behavior of the material can be extremely informative. The only information known for the sample is the fraction of its constituting particles. Thus, the high-fidelity data sets used in this section consist of the aging behavior of the remaining available samples. In addition, the low-fidelity data sets are generated based on the TCC model and Support Vector Machine (SVM) predicted model parameters. For details of predictions based on sample components please refer to previous part of this manuscript. We note that the DNN utilizes the entire high-fidelity data set and does not include the low-fidelity predictions. FIG. 16 clearly shows that by using DNN and feeding the aging information of other samples, an erroneous trend is predicted for all ages of an unknown sample. One can argue that the trend of DNN predictions remains rather unchanged as well. This includes a thinning regime followed by a slight thickening regime and a second thinning at highest shear rates. This is due to deviations in predictions of the fresh sample to begin with. In contrast, the MFNN algorithm closely predicts the viscosity behavior at all ages with negligible deviations from the experimental measurements.

### IV. Conclusion

In this work, we introduced and studied the performance of an adaptable and comprehensive data-driven algorithm for constitutive meta-modeling of complex fluids with respect to their rheological behavior. The proposed Multi-Fidelity Neural Network, MFNN, is capable of taking advantage of high-fidelity experimental (or high-resolution simulation data) and an abundance of synthetically generated low-fidelity data using different constitutive models at hand. This provides an extremely powerful platform for employing data-driven and machine learning algorithms in areas of research where often small sizes of data available prevents a meaningful predictive capability to be devised. In contrary, the simple classical DNN, without a physical basis is not able to reflect on real behavior of the material. This is mainly due to the fact that in purely data-driven methods, an abundance of data is required to provide a meaningful machine learning algorithm to be deployed, which is often not the case for rheological measurements. Our results showed that the DNNs are incapable of recovering the realistic rheological behavior; how-ever, incorporation of a physical intuition into the neural net-work architecture in the form of low-fidelity data generated through constitutive models significantly improves the predictive ability of the algorithm. We further investigated the role of the accuracy of constitutive models employed to generate the synthetic data, and found that while even an over-simplistic model such as power-law improves upon accuracy of the DNNs in MFNN framework, including the fundamental rheological intuitions such as emergence of a yield stress in a Herschel-Bulkley model can result in recovering the experimental observations through MFNN. More importantly, we showed that the MFNN can be used to provide a rather accurate prediction of an entirely new sample with only known components and their compositions. The MFNN is found to leverage the physical and phenomenological advantages of constitutive models, as well as data-driven learning of the actual experimental measurements, in providing a predictive capability. This can be explained by contrasting the fundamental differences in constitutive/phenomenological modeling versus data-driven modeling. In constitutive and theoretical modeling, system variables and material-specific constituents and compositions are reduced and collectively represented through a number of model parameters. On the other hand, each component, system variable or process condition can be used as an input parameter to the NN, without the need for reduced-order modeling. Relying on the physically-informed methodologies proposed here, and individual contribution of different components, the MFNN enables prediction of rheology directly from formulation, offering a significant leap in material design and discovery.

Subsequently, we demonstrated the applicability of our proposed method as alternative constitutive meta-models for predicting the viscosity behavior of a complex multi-component fluid under different thermomechanical and thermochemical conditions. In particular, the role of experiment temperature, salt-level and sample aging on steady shear flow curves were studied using simple DNN and MFNN. We showed that once the appropriate physical intuition is carried through the low fidelity data sets, the MFNN captures the rheological behavior of the sample within or outside the range of training data points and parameters. This is of utmost relevance, and importance in many real-world material design protocols, where an informed prediction of the physical and rheological behavior of a material based on its formulation can be transformative. This was clearly demonstrated through MFNN-predicted viscosity behavior of a sample based on its constituents over a period of 1 year.

While the MFNN architecture proposed in this paper shows a great promise as an alternative data-driven constitutive meta-model for complex fluids, one must always cautiously employ such statistical methodologies with careful choice of physics that the model adheres to. For instance, here we only used rather simple Generalized Newtonian Fluids (GNF) constitutive models of choice. While GNFs are very useful in describing the rate-dependent viscosity of a complex fluid in shear flows, they are unable to provide any meaningful description of time-dependent, or elastic effects. The MFNN (or any similar physics-based machine-learning algorithm) relies directly on the choice of physics made to describe a phenomenon. Thus, a wrong choice of model will likely result in erroneous predictions, even when mitigated through abundance of experimental data.

We reported on devising and utilizing a physics-based multi-fidelity NN architecture to predict the simple shear rheological behavior of a complex system. However, the physical intuition of the problem under investigation does not require to be in the form of low fidelity data, and can be manifested through direct differential equations that the algorithm has to comply with. We believe that such methodologies can be extremely powerful and practical, leveraging the advances in machine-learning algorithms without compromising the essential physical and rheological underpinnings of the phenomena at hand. Nonetheless, one should note that the physical basis present in the MFNN is not limited to generated data from constitutive models, and can be extended to instead directly solve functional forms and partial differential equations, expanding the window of applications of these methods to various flow conditions and rheological investigations.

### Appendix A

Residual and Loss: Here, we present the convergence comparison as well as the residual losses for both DNN and MFNN architecture. As mentioned, the MFNN contains both the low-fidelity and high-fidelity parts to detect the relation between the inputs and output accurately. To better training the MFNN, the losses from both low-fidelity and high-fidelity networks should be minimized. FIG. 17 presents the residual losses for both parts as well as the total loss of the training process. DNN on the other hand, has a much simpler architecture. Therefore, there will be only one function to minimize to find the relation between inputs and output. The residual behavior of the DNN is also shown in FIG. 17. It should be noted that throughout this work, we have been using a combination of Adams optimizer and LBFG-S method together with Xavier's initialization method to optimize the loss function, while the hyperbolic tangent function is employed as the activation function.

Architecture of Neural Networks: Throughout this work, the loss function is optimized using a combination of Adams optimizer and LBFG-S method together with Xavier's initialization method, while the hyperbolic tangent function is employed as the activation function for DNN, low-fidelity NN, and non-linear part of the high-fidelity NN. It should be noted that the linear part of the high-fidelity NN does not have an activation function due to the fact that it is used to approximate the linear part of the relation between inputs and output. The architecture of the DNN is three layers with 20 neurons in each layer. On the other hand, the architecture of the MFNN is two layers with 20 neurons per layer for low-fidelity NN as well as two layers with ten neurons per layer for non-linear part of the high-fidelity NN.

Computational resources and required time: Through-out this study, all the training processes are performed on a normal computer without any specific requirements. The runtime for each training in average is less than one hour. In other words, with only one hour of proper training one could have a pretty accurate predictions as good as the ones shown above.

The methods, operations, modules, and systems described herein may be implemented in one or more computer programs executing on a programmable computer system. FIG. 21 is a simplified block diagram illustrating an exemplary computer system 100, on which the computer programs may operate as a set of computer instructions. The computer system 100 includes at least one computer processor 102, system memory 104 (including a random access memory and a read-only memory) readable by the processor 102. The computer system 100 also includes a mass storage device 106 (e.g., a hard disk drive, a solid-state storage device, an optical disk device, etc.). The computer processor 102 is capable of processing instructions stored in the system memory or mass storage device. The computer system 100 additionally includes input/output devices 108, 110 (e.g., a display, keyboard, pointer device, etc.), a graphics module 112 for generating graphical objects, and a communication module or network interface 114, which manages communication with other devices via telecommunications and other networks.

Each computer program can be a set of instructions or program code in a code module resident in the random access memory of the computer system. Until required by the computer system, the set of instructions may be stored in the mass storage device or on another computer system and downloaded via the Internet or other network.

Having thus described several illustrative embodiments, it is to be appreciated that various alterations, modifications, and improvements will readily occur to those skilled in the art. Such alterations, modifications, and improvements are intended to form a part of this disclosure, and are intended to be within the spirit and scope of this disclosure. While some examples presented herein involve specific combinations of functions or structural elements, it should be understood that those functions and elements may be combined in other ways according to the present disclosure to accomplish the same or different objectives. In particular, acts, elements, and features discussed in connection with one embodiment are not intended to be excluded from similar or other roles in other embodiments.

Additionally, elements and components described herein may be further divided into additional components or joined together to form fewer components for performing the same functions. For example, the computer system may comprise one or more physical machines, or virtual machines running on one or more physical machines. In addition, the computer system may comprise a cluster of computers or numerous distributed computers that are connected by the Internet or another network.

Accordingly, the foregoing description and attached drawings are by way of example only, and are not intended to be limiting.

### REFERENCES

1. P. R. de Souza Mendes, “Thixotropic elasto-viscoplastic model for structured fluids,” Soft Matter 7, 2471 (2011).

2. J. Colombo and E. Del Gado, “Stress localization, stiffening, and yielding in a model colloidal gel,” Journal of Rheology 58, 1089-1116 (2014).

3. A. K. Gurnon and N. J. Wagner, “Microstructure and rheology relationships for shear thickening colloidal dispersions,” Journal of Fluid Mechanics 769, 242-276 (2015).

4. S. A. Rogers, D. Vlassopoulos, and P. T. Callaghan, “Aging, Yielding, and Shear Banding in Soft Colloidal Glasses,” Physical Review Letters 100, 128304 (2008).

5. C. J. Dimitriou and G. H. McKinley, “A comprehensive constitutive law for waxy crude oil: a thixotropic yield stress fluid,” Soft Matter 10, 6619-6644 (2014).

6. W. M. Gelbart and A. Ben-Shaul, “The “New” Science of “Complex Fluids”,” The Journal of Physical Chemistry 100, 13169-13189 (1996).

7. J. Vermant and M. J. Solomon, “Flow-induced structure in colloidal suspensions,” Journal of Physics: Condensed Matter 17, R187-R216 (2005).

8. K. Masschaele, J. Fransaer, and J. Vermant, “Flow-induced structure in colloidal gels: direct visualization of model 2D suspensions,” Soft Matter 7, 7717-7726 (2011).

9. W. H. Herschel and R. Bulkley, “Konsistenzmessungen von Gummi-Benzöllosungen,” Kolloid-Zeitschrift 39, 291-300 (1926).

10. E. C. Bingham, “An investigation of the laws of plastic flow,” Bulletin of the Bureau of Standards 13, 309 (1916).

11. T. Gillespie, “An extension of Goodeve's impulse theory of viscosity to pseudoplastic systems,” Journal of Colloid Science 15, 219-231 (1960).

12. R. B. Bird and O. Hassager, Dynamics of Polymeric Liquids: Fluid mechanics, Dynamics of Polymeric Liquids (Wiley, 1987).

13. F. A. Morrison and A. Morrison, Understanding Rheology, Raymond F. Boyer Library Collection (Oxford University Press, 2001).

14. C. W. Macosko, Rheology: principles, measurements, and applications, Advances in interfacial engineering series (VCH, 1994).

15. T. G. Mezger, The rheology handbook: for users of rotational and oscillatory rheometers (2., rev. ed.) (Hannover: Vincentz Network, 2006).

16. R. P. Heldman and D. R. Singh, Introduction to food engineering (5th ed.) (Amsterdam: Elsevier, 2013).

17. P. C. Coleman and M. M. Painter, Fundamentals of polymer science: an introductory text (2nd ed.) (Lancaster, Pa.: Technomic, 1997).

18. D. Bonn, M. M. Denn, L. Berthier, T. Divoux, and S. Manneville, “Yield stress materials in soft condensed matter,” Reviews of Modern Physics 89, 35005 (2017).

19. P. Coussot, “Yield stress fluid flows: A review of experimental data,” Journal of Non-Newtonian Fluid Mechanics 211, 31-49 (2014).

20. J.-Y. Kim, J.-Y. Song, E.-J. Lee, and S.-K. Park, “Rheological properties and microstructures of Carbopol gel network system,” Colloid and Polymer Science 281, 614-623 (2003).

21. I. Kaneda and A. Sogabe, “Rheological properties of water swellable mi-crogel polymerized in a confined space,” Colloids and Surfaces A: Physicochemical and Engineering Aspects 270, 163-170 (2005).

22. G. Petekidis, D. Vlassopoulos, and P. Pusey, “Yielding and flow of sheared colloidal glasses,” Journal of Physics: Condensed Matter 16, 53955 (2004).

23. A. Ghosh, G. Chaudhary, J. G. Kang, P. V. Braun, R. H. Ewoldt, and K. S. Schweizer, “Linear and nonlinear rheology and structural relaxation in dense glassy and jammed soft repulsive pNIPAM microgel suspensions,” Soft Matter 15, 1038-1052 (2019).

24. C. Pellet and M. Cloitre, “The glass and jamming transitions of soft poly-electrolyte microgel suspensions,” Soft Matter 12, 3710-3720 (2016).

25. N. Koumakis, A. Pamvouxoglou, A. S. Poulos, and G. Petekidis, “Direct comparison of the rheology of model hard and soft particle glasses,” Soft Matter 8, 4271-4284 (2012).

26. M. Caggioni, V. Trappe, and P. T. Spicer, “Variations of the Herschel-Bulkley exponent reflecting contributions of the viscous continuous phase to the shear rate-dependent stress of soft glassy materials,” Journal of Rheology 64, 413-422 (2020).

27. P. Hébraud and F. Lequeux, “Mode-coupling theory for the pasty rheology of soft glassy materials,” Physical review letters 81, 2934-2937 (1998).

28. L. Bocquet, A. Colin, and A. Ajdari, “Kinetic theory of plastic flow in soft glassy materials,” Physical review letters 103, 36001 (2009).

29. J. R. Seth, L. Mohan, C. Locatelli-Champagne, M. Cloitre, and R. T. Bonnecaze, “A micromechanical model to predict the flow of soft particle glasses,” Nature materials 10, 838-843 (2011).

30. M. E. Helgeson, S. E. Moran, H. Z. An, and P. S. Doyle, “Mesoporous organohydrogels from thermogelling photocrosslinkable nanoemulsions,” Nature Materials 11, 344-352 (2012).

31. A. Mohraz and M. J. Solomon, “Orientation and rupture of fractal colloidal gels during start-up of steady shear flow,” Journal of Rheology 49, 657-681 (2005).

32. L. C. Hsiao, R. S. Newman, S. C. Glotzer, and M. J. Solomon, “Role of isostaticity and load-bearing microstructure in the elasticity of yielded colloidal gels,” Proceedings of the National Academy of Sciences 109, 16029-16034 (2012).

33. B. J. Maranzano and N. J. Wagner, “The effects of interparticle interactions and particle size on reversible shear thickening: Hard-sphere colloidal dispersions,” Journal of Rheology 45, 1205-1222 (2001).

34. L. Cipelletti, S. Manley, R. C. Ball, and D. A. Weitz, “Universal Aging Features in the Restructuring of Fractal Colloidal Gels,” Physical Review Letters 84, 2275-2278 (2000).

35. R. N. Zia, B. J. Landrum, and W. B. Russel, “A micro-mechanical study of coarsening and rheology of colloidal gels: Cage building, cage hopping, and Smoluchowski's ratchet,” Journal of Rheology 58, 1121-1157 (2014).

36. B. J. Landrum, W. B. Russel, and R. N. Zia, “Delayed yield in colloidal gels: Creep, flow, and re-entrant solid regimes,” Journal of Rheology 60, 783-807 (2016).

37. H. C. W. Chu and R. N. Zia, “Active microrheology of hydrodynamically interacting colloids: Normal stresses and entropic energy density,” Journal of Rheology 60, 755-781 (2016).

38. S. Jamali, G. H. McKinley, and R. C. Armstrong, “Microstructural Rearrangements and their Rheological Implications in a Model Thixotropic Elastoviscoplastic Fluid,” Physical Review Letters 118, 048003 (2017).

39. A. Boromand, S. Jamali, and J. M. Maia, “Structural fingerprints of yielding mechanisms in attractive colloidal gels,” Soft Matter 13, 458-473 (2017).

40. J. Kim, D. Merger, M. Wilhelm, and M. E. Helgeson, “Microstructure and nonlinear signatures of yielding in a heterogeneous colloidal gel under large amplitude oscillatory shear,” Journal of Rheology 58, 1359-1390 (2014).

41. Y. Gao, J. Kim, and M. E. Helgeson, “Microdynamics and arrest of coarsening during spinodal decomposition in thermoreversible colloidal gels,” Soft Matter 11, 6360-6370 (2015).

42. J. Min Kim, A. P. R. Eberle, A. Kate Gurnon, L. Porcar, and N. J. Wagner, “The microstructure and rheology of a model, thixotropic nanoparticle gel under steady shear and large amplitude oscillatory shear (LAOS),” Journal of Rheology 58, 1301-1328 (2014).

43. M. J. Solomon and P. T. Spicer, “Microstructural regimes of colloidal rod suspensions, gels, and glasses,” Soft Matter 6, 1391 (2010).

44. C. J. Dibble, M. Kogan, and M. J. Solomon, “Structure and dynamics of colloidal depletion gels: Coincidence of transitions and heterogeneity,” Physical Review E 74, 041403 (2006).

45. E. M. Furst and J. P. Pantina, “Yielding in colloidal gels due to nonlinear microstructure bending mechanics,” Physical Review E 75, 050402 (2007).

46. L. C. Johnson, B. J. Landrum, and R. N. Zia, “Yield of reversible colloidal gels during flow start-up: release from kinetic arrest,” Soft Matter 14, 5048-5068 (2018).

47. L. C. Johnson, R. N. Zia, E. Moghimi, and G. Petekidis, “Influence of structure on the linear response rheology of colloidal gels,” Journal of Rheology 63, 583-608 (2019).

48. N. Y. C. Lin, B. M. Guy, M. Hermes, C. Ness, J. Sun, W. C. K. Poon, and I. Cohen, “Hydrodynamic and Contact Contributions to Continuous Shear Thickening in Colloidal Suspensions,” Physical Review Letters 115, 228304 (2015).

49. J. F. Berret, “Rheology of Wormlike Micelles: Equilibrium Properties and Shear Banding Transition,” (2004), arXiv:0406681 (condmat).

50. J. P. Rothstein, “Transient extensional rheology of wormlike micelle solutions,” Journal of Rheology 47, 1227-1247 (2003).

51. J. T. Padding, E. S. Boek, and W. J. Briels, “Rheology of wormlike micellar fluids from Brownian and molecular dynamics simulations,” Journal of Physics: Condensed Matter 17, S3347-S3353 (2005).

52. J. T. Padding, E. S. Boek, and W. J. Briels, “Dynamics and rheology of wormlike micelles emerging from particulate computer simulations,” The Journal of Chemical Physics 129, 074903 (2008).

53. J. T. Padding, W. J. Briels, M. R. Stukan, and E. S. Boek, “Review of multi-scale particulate simulation of the rheology of wormlike micellar fluids,” Soft Matter 5, 4367 (2009).

54. Y. Zhao, S. J. Haward, and A. Q. Shen, “Rheological characterizations of wormlike micellar solutions containing cationic surfactant and anionic hydrotropic salt,” Journal of Rheology 59, 1229-1259 (2015).

55. R. G. Larson, “Constitutive equations for thixotropic fluids,” Journal of Rheology 59, 595-611 (2015).

56. S. Jamali, R. C. Armstrong, and G. H. McKinley, “Multiscale Nature of Thixotropy and Rheological Hysteresis in Attractive Colloidal Suspensions under Shear,” Physical Review Letters 123, 248003 (2019).

57. S. Jamali, R. C. Armstrong, and G. H. McKinley, “Time-rate-transformation framework for targeted assembly of short-range attractive colloidal suspensions,” Materials Today Advances 5, 100026 (2020).

58. T. Divoux, V. Grenard, and S. Manneville, “Rheological Hysteresis in Soft Glassy Materials,” Physical Review Letters 110, 018304 (2013).

59. J. Mewis and N. J. Wagner, “Thixotropy,” Advances in Colloid and Interface Science 147-148, 214-227 (2009).

60. P. R. de Souza Mendes and R. L. Thompson, “A critical overview of elasto-viscoplastic thixotropic modeling,” Journal of Non-Newtonian Fluid Mechanics 187-188, 8-15 (2012).

61. Y. Wei, M. J. Solomon, and R. G. Larson, “Quantitative nonlinear thixotropic model with stretched exponential response in transient shear flows,” Journal of Rheology 60, 1301-1315 (2016).

62. P. Coussot, Q. D. Nguyen, H. T. Huynh, and D. Bonn, “Viscosity bifurcation in thixotropic, yielding fluids,” Journal of Rheology 46, 573-589 (2002).

63. C. F. Goodeve and G. W. Whitfield, “The measurement of thixotropy in absolute units,” Transactions of the Faraday Society 34, 511 (1938).

64. K. A. Janes and M. B. Yaffe, “Data-driven modelling of signal-transduction networks,” Nature Reviews Molecular Cell Biology 7, 820-828 (2006).

65. D. P. Solomatine and A. Ostfeld, “Data-driven modelling: some past experiences and new approaches,” Journal of Hydroinformatics 10, 3-22 (2008).

66. D. Solomatine, L. See, and R. Abrahart, “Data-Driven Modelling: Concepts, Approaches and Experiences,” in Practical Hydroinformatics (Springer Berlin Heidelberg, Berlin, Heidelberg) pp. 17-30.

67. C. Bishop, Pattern Recognition and Machine Learning (Springer-Verlag New York, 2006) pp. XX-738.

68. S. L. Brunton, B. R. Noack, and P. Koumoutsakos, “Machine Learning for Fluid Mechanics,” Annual Review of Fluid Mechanics 52, 477-508 (2020).

69. W. Chang, X. Chu, A. F. B. S. Fareed, S. Pandey, J. Luo, B. Weigand, and E. Laurien, “Heat transfer prediction of supercritical water with artificial neural networks,” Applied Thermal Engineering 131, 815-824 (2018).

70. M. Mahmoudabadbozchelou, A. Eghtesad, S. Jamali, and H. Afshin, “Entropy analysis and thermal optimization of nanofluid im-pinging jet using artificial neural network and genetic algorithm,” International Communications in Heat and Mass Transfer 119 (2020), 10.1016/j .icheatmasstransfer.2020.104978.

71. M. Mohanraj, S. Jayaraj, and C. Muraleedharan, “Applications of artificial neural networks for thermal analysis of heat exchangers—A review,” International Journal of Thermal Sciences 90, 150-172 (2015).

72. M. Mahmoudabadbozchelou, N. Rabiei, and M. Bazargan, “Numerical and Experimental Investigation of the Optimization of Vehicle Speed and Inter-Vehicle Distance in an Automated Highway Car Platoon to Minimize Fuel Consumption,” SAE Intl. J CAV 1, 3-12 (2018).

73. J. Rabault, J. Kolaas, and A. Jensen, “Performing particle image velocimetry using artificial neural networks: a proof-of-concept,” Measurement Science and Technology 28, 125301 (2017).

74. A. Eghtesad, M. Mahmoudabadbozchelou, and H. Afshin, “Heat transfer optimization of twin turbulent sweeping impinging jets,” International Journal of Thermal Sciences 146, 106064 (2019).

75. G. Xie, B. Sunden, Q. Wang, and L. Tang, “Performance predictions of laminar and turbulent heat transfer and fluid flow of heat exchangers having large tube-diameter and large tube-row by artificial neural networks,” International Journal of Heat and Mass Transfer 52, 2484-2497 (2009).

76. J. Sirignano and K. Spiliopoulos, “DGM: A deep learning algorithm for solving partial differential equations,” Journal of Computational Physics 375, 1339-1364 (2018).

77. R. Poplin, A. V. Varadarajan, K. Blumer, Y. Liu, M. V. McConnell, G. S. Corrado, L. Peng, and D. R. Webster, “Prediction of cardiovascular risk factors from retinal fundus photographs via deep learning,” Nature Biomedical Engineering 2, 158-164 (2018).

78. B. Kim, V. C. Azevedo, N. Thuerey, T. Kim, M. Gross, and B. Solen-thaler, “Deep Fluids: A Generative Network for Parameterized Fluid Simulations,” Computer Graphics Forum 38, 59-70 (2019).

79. N. Geneva and N. Zabaras, “Quantifying model form uncertainty in Reynolds-averaged turbulence models with Bayesian deep neural networks,” Journal of Computational Physics 383, 125-147 (2019).

80. D. Lu, M. Heisler, S. Lee, G. Ding, M. V. Sarunic, and M. F. Beg, “Retinal Fluid Segmentation and Detection in Optical Coherence Tomography Images using Fully Convolutional Neural Network,” (2017), arXiv:1710.04778.

81. T. Murata, K. Fukami, and K. Fukagata, “Nonlinear mode decomposition with convolutional neural networks for fluid dynamics,” Journal of Fluid Mechanics 882, A13 (2020).

82. A. Rashno, D. D. Koozekanani, and K. K. Parhi, “OCT Fluid Segmentation using Graph Shortest Path and Convolutional Neural Network*,” in 2018 40th Annual International Conference of the IEEE Engineering in Medicine and Biology Society (EMBC) (2018) pp. 3426-3429.

83. C. Smith, J. Doherty, and Y. Jin, “Multi-objective evolutionary recurrent neural network ensemble for prediction of computational fluid dynamic simulations,” in 2014 IEEE Congress on Evolutionary Computation (CEC) (2014) pp. 2609-2616.

84. C. Liao, K. Wang, M. Yu, and W. Chen, “Modeling of Magnetorheological Fluid Damper Employing Recurrent Neural Networks,” in 2005 International Conference on Neural Networks and Brain, Vol. 2 (2005) pp. 616-620.

85. M. Raissi, P. Perdikaris, and G. Karniadakis, “Physics-informed neural networks: A deep learning framework for solving forward and inverse problems involving nonlinear partial differential equations,” Journal of Computational Physics 378, 686-707 (2019).

86. X. Meng, Z. Li, D. Zhang, and G. E. Karniadakis, “PPINN: Parareal Physics-Informed Neural Network for time-dependent PDEs,” 1-17 (2019), arXiv:1909.10145.

87. X. Meng and G. E. Karniadakis, “A composite neural network that learns from multi-fidelity data: Application to function approximation and inverse PDE problems,” Journal of Computational Physics 401, 109020 (2020), arXiv:1903.00104.

88. G. Pang, L. Lu, and G. E. Karniadakis, “fPINNs: Fractional Physics-Informed Neural Networks,” 35, 225-253 (2018), arXiv:1811.08967.

89. G. Pang, M. D'Elia, M. Parks, and G. E. Karniadakis, “nPINNs: nonlocal Physics-Informed Neural Networks for a parametrized nonlocal universal Laplacian operator. Algorithms and Applications,” (2020), arXiv:2004.04276.

90. L. Lu, P. Jin, and G. E. Karniadakis, “DeepONet: Learning nonlinear operators for identifying differential equations based on the universal approximation theorem of operators,” , 1-22 (2019), arXiv:1910.03193.

91. L. Lu, X. Meng, Z. Mao, and G. E. Karniadakis, “DeepXDE: A deep learning library for solving differential equations,” , 1-17 (2019), arXiv:1907.04502.

92. J. X. Wang, J. L. Wu, and H. Xiao, “Physics-informed machine learning approach for reconstructing Reynolds stress modeling discrepancies based on DNS data,” Physical Review Fluids 2, 1-22 (2017), arXiv:1606.07987.

93. J. L. Wu, H. Xiao, and E. Paterson, “Physics-informed machine learning approach for augmenting turbulence models: A comprehensive framework,” Physical Review Fluids 7, 1-28 (2018), arXiv:1801.02762.

94. R. Swischuk, L. Mainini, B. Peherstorfer, and K. Willcox, “Projection-based model reduction: Formulations for physics-based machine learning,” Computers & Fluids 179, 704-717 (2019).

95. X. Jia, J. Willard, A. Karpatne, J. S. Read, J. A. Zwart, M. Steinbach, and V. Kumar, “Physics-Guided Machine Learning for Scientific Discovery: An Application in Simulating Lake Temperature Profiles,” , 1-25 (2020), arXiv:2001.11086.

96. C. Rackauckas, Y. Ma, J. Martensen, C. Warner, K. Zubov, R. Supekar, D. Skinner, and A. Ramadhan, “Universal Differential Equations for Scientific Machine Learning,” (2020), arXiv:2001.04385.

97. R. Piazza and G. D. Pietro, “Phase separation and gel-like structures in mixtures of colloids and surfactant,” Europhysics Letters (EPL) 28, 445-450 (1994).

98. G. Petekidis, L. Galloway, S. Egelhaaf, M. Cates, and W. Poon, “Mixtures of colloids and wormlike micelles: Phase behavior and kinetics,” Langmuir 18, 4248-4257 (2002).

99. M. G. Fernandez-Godino, C. Park, N. H. Kim, and R. T. Haftka, “Review of multi-fidelity models,” (2016), arXiv:1609.07196.

100. D. Zhang, L. Lu, L. Guo, and G. E. Karniadakis, “Quantifying total uncertainty in physics-informed neural networks for solving forward and inverse stochastic problems,” Journal of Computational Physics 397, 108850 (2019).

101. G. M. Foody and M. K. Arora, “An evaluation of some factors affecting the accuracy of classification by an artificial neural network,” International Journal of Remote Sensing 18, 799-810 (1997).

1. A computer-implemented method of predicting one or more rheological properties of a non-Newtonian fluid using a multi-fidelity neural network framework, the method comprising steps performed by a computer system of:
(a) receiving, at a physics-informed low fidelity neural network, a plurality of low fidelity parameter inputs related to the non-Newtonian fluid;
(b) generating, by the physics-informed low fidelity neural network, one or more synthetically generated parameters of the non-Newtonian fluid based on the plurality of low fidelity parameter inputs;
(c) receiving, at a physics-informed high fidelity neural network, the at least one or more synthetically generated parameters of the non-Newtonian fluid and one or more high fidelity parameter inputs related to the non-Newtonian fluid;
(d) generating, by the physics-informed high fidelity neural network, the one or more rheological properties of the non-Newtonian fluid based on the high fidelity parameter inputs and the at least one or more synthetically generated parameters related to the non-Newtonian fluid; and
(e) outputting, by the computer system, the one or more rheological properties of the non-Newtonian fluid generated in (d).

2. The method of claim 1, wherein the one or more high fidelity parameter inputs comprise experimental data relating to the non-Newtonian fluid.

3. The method of claim 1, wherein the one or more high fidelity parameter inputs comprise high resolution synthetic data relating to the non-Newtonian fluid.

4. The method of claim 1, wherein the physics-informed high fidelity neural network includes a linear portion and a non-linear portion.

5. The method of claim 1, wherein the plurality of low fidelity parameter inputs related to the non-Newtonian fluid includes at least one or more constituents and one or more flow properties of the non-Newtonian fluid.

6. The method of claim 1, wherein the physics-informed low fidelity neural network is rheologically-informed.

7. The method of claim 1, wherein the physics-informed high fidelity neural network is rheologically-informed.

8. A computer system, comprising:
at least one processor;
memory associated with the at least one processor; and
a program stored in the memory for predicting one or more rheological properties of a non-Newtonian fluid using a multi-fidelity neural network framework, the program containing a plurality of instructions which, when executed by the at least one processor, cause the at least one processor to:
(a) receive, at a physics-informed low fidelity neural network, a plurality of low fidelity parameter inputs related to the non-Newtonian fluid;
(b) generate, by the physics-informed low fidelity neural network, one or more synthetically generated parameters of the non-Newtonian fluid based on the plurality of low fidelity parameter inputs;
(c) receive, at a physics-informed high fidelity neural network, the at least one or more synthetically generated parameters of the non-Newtonian fluid and one or more high fidelity parameter inputs related to the non-Newtonian fluid;
(d) generate, by the physics-informed high fidelity neural network, the one or more rheological properties of the non-Newtonian fluid based on the high fidelity parameter inputs and the at least one or more synthetically generated parameters related to the non-Newtonian fluid; and
(e) output, by the computer system, the one or more rheological properties of the non-Newtonian fluid generated in (d).

9. The system of claim 8, wherein the one or more high fidelity parameter inputs comprise experimental data relating to the non-Newtonian fluid.

10. The system of claim 8, wherein the one or more high fidelity parameter inputs comprise high resolution synthetic data relating to the non-Newtonian fluid.

11. The system of claim 8, wherein the physics-informed high fidelity neural network includes a linear portion and a non-linear portion.

12. The system of claim 8, wherein the plurality of low fidelity parameter inputs related to the non-Newtonian fluid includes at least one or more constituents and one or more flow properties of the non-Newtonian fluid.

13. The system of claim 8, wherein the physics-informed low fidelity neural network is rheologically-informed.

14. The system of claim 8, wherein the physics-informed high fidelity neural network is rheologically-informed.

15. A computer program product for predicting one or more rheological properties of a non-Newtonian fluid using a multi-fidelity neural network framework, said computer program product residing on a non-transitory computer readable medium having a plurality of instructions stored thereon which, when executed by a computer processor, cause that computer processor to: (a) receive, at a physics-informed low fidelity neural network, a plurality of low fidelity parameter inputs related to the non-Newtonian fluid; (b) generate, by the physics-informed low fidelity neural network, one or more synthetically generated parameters of the non-Newtonian fluid based on the plurality of low fidelity parameter inputs; (c) receive, at a physics-informed high fidelity neural network, the at least one or more synthetically generated parameters of the non-Newtonian fluid and one or more high fidelity parameter inputs related to the non-Newtonian fluid; (d) generate, by the physics-informed high fidelity neural network, the one or more rheological properties of the non-Newtonian fluid based on the high fidelity parameter inputs and the at least one or more synthetically generated parameters related to the non-Newtonian fluid; and (e) output the one or more rheological properties of the non-Newtonian fluid generated in (d).

16. The computer program product of claim 15, wherein the one or more high fidelity parameter inputs comprise experimental data relating to the non-Newtonian fluid.

17. The computer program product of claim 15, wherein the one or more high fidelity parameter inputs comprise high resolution synthetic data relating to the non-Newtonian fluid.

18. The computer program product of claim 15, wherein the physics-informed high fidelity neural network includes a linear portion and a non-linear portion.

19. The computer program product of claim 15, wherein the plurality of low fidelity parameter inputs related to the non-Newtonian fluid includes at least one or more constituents and one or more flow properties of the non-Newtonian fluid.

20. The computer program product of claim 15, wherein the physics-informed low fidelity neural network is rheologically-informed, and the physics-informed high fidelity neural network is rheologically-informed.
